(19) United States
(12) Patent Application Publication
(10) Pub. No.: US 2024/0399337 A1
(43) Pub. Date: Dec. 5, 2024

(54) SORBENTS FOR TRACE CONTAMINATION CONTROL SYSTEMS

(71) Applicant: XPLOSAFE, LLC, STILLWATER, OK (US)

(72) Inventors: Nicholas F. MATERER, Stillwater, OK (US); Shoaib F. SHAIKH, Stillwater, OK (US); Evgueni B. KADOSSOV, Stillwater, OK (US); Michael L. TEICHEIRA, Stillwater, OK (US); Hanna R. ANDERSON, Stillwater, OK (US); John R. TIDWELL, Stillwater, OK (US); ALLEN W. APBLETT, Stillwater, OK (US)

(73) Assignee: XPLOSAFE, LLC, STILLWATER, OK (US)

(21) Appl. No.: 18/675,957

(22) Filed: May 28, 2024

Related U.S. Application Data
(63) Continuation of application No. PCT/US24/31261, filed on May 28, 2024.
(60) Provisional application No. 63/505,273, filed on May 31, 2023.

(51) Int. Cl. B01J 20/26; B01D 53/047; B01J 20/28; B01J 20/34

(52) U.S. Cl. CPC B01J 20/262; B01D 53/047; B01J 20/28004; B01J 20/28011; B01J 20/2805; B01J 20/3491; B01D 2253/202; B01D 2253/304; B01D 2253/311; B01D 2258/06

(57) ABSTRACT

The present invention provides improved sorbents and corresponding device(s) and uses thereof for the capture of contaminants from breathable air in an enclosed habitable space. The sorbents are capable of rapid and high adsorption of moisture, carbon dioxide and other contaminants from forced air and provide quantitative release of the sorbates when exposed to vacuum. The sorbents may be included in air treatment systems, such as portable life support systems (trace contaminant control systems), to maintain a breathable atmosphere in spacecraft, watercraft, or landcraft having enclosed habitable spaces and also in space suits.

### CROSS-REFERENCES TO EARLIER FILED APPLICATIONS

The present application claims the benefit of priority of application No. U.S. 63/505,273 filed May 31, 2023, and of application No. PCT/US24/31261 filed May 28, 2024, the entire disclosures of which are hereby incorporated by reference.

### STATEMENT REGARDING FEDERALLY SPONSORED RESEARCH

This invention was made with government support under contracts No. 80NSSC20C0554, No. 80NSSC21C0579, No. 80NSSC22PB246, No. 80NSSC23CA167 awarded by the Small Business Innovation Research program. The government has certain rights in the invention.

### FIELD OF THE INVENTION

The present invention concerns improved sorbents, a trace contamination control system, apparatus, and methods used to capture and remove sorbates, such as trace contaminants, carbon dioxide, and moisture from air in a closed habitable environment. More particularly, the invention concerns systems and methods employing vacuum regenerable sorbent material that captures and releases moisture and carbon dioxide and vacuum regenerable sorbent that captures and releases volatile and semi-volatile compounds (contaminants) from air in a closed habitable environment, thereby rendering the air safe and breathable. The invention also concerns an air treatment system containing one or both of said sorbents. The invention also concerns an apparatus for testing the performance of such sorbents and air treatment system.

### BACKGROUND OF THE INVENTION

NASA is poised to make the next step out into the solar system with Human Exploration of the Moon, Mars, and beyond. Highly reliable, efficient, capable, and reliable spacesuits are one of the keys to the success of this effort. The development is underway for the next generation of space suits called the Extra-Vehicular Mobility Unit (xEMU). The Exploration Portable Life Support Subsystem (xPLSS) is a vitally important component of the xEMU that is also being developed. The xPLSS is tasked with the maintenance of a breathable atmosphere that is free of noxious volatile molecular species. The purification system that removes contaminants present in the ventilation system is the Trace Contamination Control System (TCC) which is a component in the ventilation loop of the xPLSS.

The safe operation of the xEMU requires control of CO₂ and humidity levels in accordance with the requirements established by the NASA medical community. Rapid Cycle Amine (RCA) technology is currently the basis for meeting this requirement in the xEMU. This technology provides regenerative CO₂ and humidity removal via a pressure swing adsorption system with a solid amine sorbent that desorbs the gases upon exposure to vacuum and requires little to no maintenance by the astronaut. Acid-impregnated activated carbon is the current state of the art for trace contamination control of other volatile and semi-volatile contaminants as described herein. The current material has limits regarding capacity of uptake for water and carbon dioxide, and kinetics of uptake and release of water and carbon dioxide. As this sorbate is non-regenerable consumable, there is a significant impact of logistics on future missions. The primary trace contaminants that must be removed by the sorbent include ammonia, carbon monoxide, formaldehyde, and methyl mercaptan in addition to numerous other contaminants that must be captured. These contaminants are generated by the materials from which the suit is constructed, processes within the suit, and by crewmembers themselves. Accumulated contaminants such as ammonia and volatile organic compounds could pose a threat to the crewmember in the absence of a well-functioning TCC System.

Ammonasorb II is the current state-of-the art TCC sorbent. However, this non-regenerable sorbent provides a logistical impact on future missions. The replacement of the Ammonasorb II filters is required after 150 hours of extravehicular activity (EVA). The logistical impacts include storage constraints, for example on the International Space Station (ISS), and the cost of supplying these units from Earth that need to be planned around the requirements for delivery of other critical materials.

NASA has prioritized 18 volatile organic compounds (VOCs) for removal by the TCC. The contaminant list developed for the TCC consists of 18 volatile organic compounds (VOCs), for which the 7-day Spacecraft Maximum Allowable Concentrations (SMACs) are tabulated in Table 1.² Of these contaminants, ammonia (NH₃), carbon monoxide (CO), formaldehyde (CH₂O), and furan (C₄H₄O) are expected to exceed their corresponding 7-day SMAC limits.³ The emission rate of each contaminant from all sources (internally from the xPLSS and biologically generated) was taken from Reference 1. As per NASA's specifications, the TCC must be able to remove these compounds to ensure that they do not exceed the 7-day SMAC limits during an EVA. Using these limits ensures that potential exposures will never exceed the 1-hour or 24-hour SMAC limits, even after multiple EVA missions. To meet this requirement, the currently used TCC system is within an accessible area of the xPLSS to allow replacement of the sorbent filter after 150 EVA hours. The more sustainable solution would be a vacuum-regenerable sorbent that could be integrated with the xPLSS CO₂/H₂O removal system, reducing the frequency and potentially eliminating the costs and logistics of supplying replaceable sorbent filters to, for example, the International Space Station (ISS). In addition to being able to remove trace contaminants, an ideal TCC unit must have a mass under 2.0 kg, the ability to filter particles greater than 25 μm, and an operating life of 150 hours EVA time without replacing the sorbent. The unit normally operates at a sub-atmospheric pressure of 430 Torr. Other specifications include functioning within the xEMU atmosphere that consists of oxygen concentrations up to 26.5% with the balance composed of nitrogen, metabolic products (CO₂ and H₂O), and trace gases. In terms of testing, the TCC system should contain an operating or ventilation loop with a pressure of 220 Torr and maximum pressure drop across the unit of 0.6 Torr (specified as 0.3 in-H₂O in Reference 1). The gas flow rate should be 170 liters per minute (lpm) or actual cubic feet per minute (6 ACFM) at a temperature between 1.7 and 51.7° C. Finally, the unit should operate in an environment with a relative humidity (RH) ranging from 1.5 to 90%.

Systems and regenerable sorbents for use in capture and removal of trace contaminants from air are known: U.S. Pat. Nos. 6,364,938B1, 2,545,194A, 3,491,031A, 4,005,708A, 4,810,266A, 4,822,383A, 4,999,175A, 5,281,254A, 5,376,614A, 5,876,488A, 4,046,592A, 4,493,741A, 6,547,854B1, 6,605,132B2, US 20030224504A1, U.S. Pat. Nos. 6,709,483B1, 6,908,497B1, US 20070169624A1, U.S. Pat. No. 7,288,136B1, WO 2008021700A1, EP 1964601A1, US 20080233019A1, US 20080296146A1, US 20090018011A1, US 20100292072A1, US 20100319537A1, US 20110041688A1, US 20110179948A1, US 20110189075A1, US 20110203174A1, US 20110219802A1, U.S. Pat. Nos. 8,221,527B1, 8,262,774B2, 8,500,861B2, 8,500,855B2, US 20130205998A1, US 20130220130A1, WO 2014104790A1, WO2015035216A1, WO2015084521A1, U.S. Pat. Nos. 9,302,247B2, 9,314,730B1, 9,316,410B2, 9,339,045B2, WO2016114991A1, US 93991872B2, U.S. Pat. Nos. 9,533,250B2, 9,908,080B2, 9,919,257B2, 10,507,453B2, EP3656456A1, U.S. Pat. Nos. 10,675,582B2, 10,850,224B2, 10,906,024B2, 10,913,026B2, 11,059,024B2, 11,229,897B2, WO2022104252A1, U.S. Ser. No. 11/446,634B2, and U.S. Pat. No. 11,541,346B2. Such systems and apparatuses can be used for treating environmental air in closed spaces such as rooms, submarines, spaceships, airplanes and automobiles.

The art also discloses devices for capture of volatile compounds: U.S. Pat. Nos. 9,370,749, 7,955,574, 9,412,573, 9,914,087, 9,901,843, 9,783,417, 9,643,186, 9,249,241, 9,079,049, 8,955,515, 8,668,873, 8,561,484, 8,500,852, 8,011,224 and 7,295,308. U.S. Pat. No. 9,370,749 to Addleman et al. discloses a porous multi-component material for capture and separation of species of interest. The material includes a substrate and a composite thin film, which comprises a combination of porous polymer and nanostructured material. The requirement of the porous polymer along with the nanostructured material is disadvantageous, because there is a significant potential of thermal degradation of the porous polymer during thermal desorption analysis of the composite thin film and a significant potential of contamination, by monomeric and dimeric species, of an extract during solvent extraction of the composite thin film.

Apblett et al. (“Synthesis of mesoporous silica grafted with 3-glycidylpropyltrimethoxy-silane” in Mater. Let. (2009), 63 (27), 2331-2334; “Preparation of mesoporous silica with grafted chelating agents for uptake of metal ions” in Chemical Engineering Journal (2009), 155 (3), 916-924; “Metal ion adsorption using polyamine-functionalized mesoporous materials prepared from bromopropyl-functionalized mesoporous silica” in Journal of Hazardous Materials (2010), 182, 581-590; “3-Aminopropyltrimethoxysilane functionalized mesoporous materials and uptake of metal Ions” in Asian J. Chem. (2011), 23 (2), 541-546) disclose the synthesis of mesoporous silica covalently grafted with various different silane groups, e.g. 3-glycidylpropyl-silane, 3-aminopropyl-silane, by treatment of mesoporous silica (OSU-6-W) with a trialkoxysilane or trihalosilane. The material was used for adsorption of divalent transition metal from aqueous solution. The OSU-6-W was prepared according to a modified method of Tuel et al. (“Synthesis and Characterization of trivalent metal containing mesoporous silicas obtained by a neutral templating route” in Chem. Mater. (1996), 8, 114) or according to a modified method of Apblett et al. (“Preparation of mesoporous silica with grafted chelating agents for uptake of metal ions” in Chemical Engineering Journal (2009), 155 (3), 916-924).

Mesoporous silica of the MCM-41 type (hexagonal; CAS 7631-86-9; linear formula SiO₂; MW 60.08) is available from Sigma Aldrich (Milwaukee, WI) and is known to possess the following physical properties.

| Linear formula | SiO₂ | |
|---|---|---|
| Form | White powder | |
| Pore size (diameter) | 2-10 | nm |
| Pore volume | 0.5-2.0 | cm³/g |
| Surface area | ~1000 | m²/g (BET) |

An MCM-41 type sorbent used for the capture of VOCs and SVOCs has been disclosed by XPLOSAFE, LLC (U.S. Pat. No. 11,458,451B2, U.S. Pat. No. 10,866,166B2, U.S. Pat. No. 10,365,075B2, U.S. Pat. No. 11,534,735B2, and 2021-0260562 A1 and used in passive sampling devices. OSU-6 sorbent consists of hexagonal arrays of tubular pores with diameters of 2-5 nm. OSU-6 is mesoporous silica sorbent. The small pore diameter (>8 nm) and high curvature of the pores lead to the ability to bind a large range of different compound types. It has a pore volume of >1.7 cm³/g, a surface area of >700 m²/g, and a channel wall thickness of >2 nm. The nanoconfinement results in very strong binding due to the enhanced attractive van der Waals forces between the adsorbate and the silica walls. The non-specific nature of the attractive forces within the OSU-6 promulgated by the nanoconfinement effect means that it is capable of sorbing with high capacity an extensive array of chemical classes including organophosphates, nitrogenated organics, chlorocarbons, ketones, aldehydes, aromatics, organic acids, alkanes, alkenes, alkynes, alcohols, freons, siloxanes, nitramines, pyrethroids, polychlorinated biphenyls, nitroaromatics, pesticides, fluorocarbons, and polynuclear aromatic hydrocarbons. OSU-6 sorbent does not contain reactive functional groups that can react with sorbates and lead to sorption retardation or release of compounds.

Nalette et al. (“Development of an amine-based system for combined carbon dioxide, humidity, and trace contaminant control.” 35th International Conference on Environmental Systems. No. Paper 2005-01-2865 (2005); “Development Status of Amine-based, Combined Humidity, CO2, and Trace Contaminant Control System for CEV.” International Conference on Environmental Systems. No. ICES-2006-01-2192 (2006)) suggest the use of SA9T sorbent in a TCC in an EVA (EMU) for capture of carbon dioxide and moisture. The sorbent is regenerated through a pressure swing cycling. The TCC employs adjacent sorbent beds that, when operated, alternate between adsorption and desorption zones. The SA9T is embedded in conductive metal foam. Even though various amine sorbents containing SA9T were prepared, they report, “The data indicate that the alternative sorbents tested thus far do not perform as well as the baseline SA9T. Therefore, they are not considered viable alternatives.” Monje et al. (“Characterizing the adsorptive capacity of SA9T using simulated spacecraft gas streams.” 40th International Conference on Environmental Systems (2010)) report the results of adsorption and desorption of water, carbon dioxide and VOCs by SA9T.

Nalette et al. (U.S. Pat. No. 6,755,892B2) discloses a TEPAN-based sorbent system for capturing carbon dioxide from fuel and gas emissions. TEPAN is the branched or linear reaction product of tetraethylenepentamine and acrylonitrile; however, they prefer secondary amines with one or more nitrile functional groups. The substrate for TEPAN can be a polymeric material, an activated charcoal material, an alumina material, or other porous material.

U.S. Pat. No. 5,876,488A discloses a sorbent comprising 35-75 wt % of hydroxyalkyl amine (primary or secondary; e.g. diethanolamine) and macroporous nonionic moderately hydrophilic acrylic ester resin (e.g. AMBERLITE XAD-7; a polyacrylic acid ester type resin ([CH₂—CH(COOR)—]ₙ)). Use of diethanolamine may cause ammonia off-gassing, which is undesirable, during use of the sorbent. AMBERLITE XAD-7 is an aliphatic adsorbent resin having a particle diameter in the range of 430-690 μm; whereas, AMBERLITE FPX66 is a nonfunctionalized adsorbent resin have a particle diameter in the range of 600-750 μm.

It would be a significant advancement in the field of trace contaminant control in air to develop devices employing regenerable sorbents with higher capacities for water and carbon dioxide, and faster kinetics for uptake and release than current sorbents. This would facilitate reduction in power draw, volume envelope, and mass while maintaining the current CO₂ and humidity removal capacity and minimizing or eliminating requirements for astronaut maintenance.

### SUMMARY OF THE INVENTION

An object of the invention is to provide improved sorbents and corresponding devices (apparatuses and systems) and methods of use that overcome one or more disadvantages of known sorbents employed in air treatment systems, e.g. trace contamination control (TCC) devices, xPLSS. The invention provides improved sorbents, devices, and methods of use, e.g. removal of sorbates such as moisture (water vapor), carbon dioxide, and/or trace contaminants from air in an enclosed habitable space. The sorbent(s) used in the invention is/are vacuum regenerable (such as through pressure swing regeneration cycling). The sorbent(s) also exhibits rapid uptake of sorbate under ambient conditions and rapid release of sorbate under mildly reduced pressure (vacuum) conditions. The invention also includes a spacecraft, watercraft, or landcraft comprising one or more containers of the invention, air testing system of the invention, and/or an air treatment system of the invention. The invention also includes a spacesuit (xEMU) comprising one or more containers of the invention, air testing system of the invention, and/or an air treatment system (TCC system, xPLSS) of the invention.

An aspect of the invention provides a sorbent comprising porous substrate derivatized with one or more polyamine adsorption modifier. In some embodiments, the polyamine adsorption modifier is selected from the group consisting of linear polyethyleneimine (PEI) polymer, modified tetraethylenepentamine (TEPA), which may be branched or linear (preferred), polyethylencamine of Formula I, and polyethyleneamine of Formula II. In some embodiments, the polyamine adsorption modifier is linear polyalkyleneimine, polyalkylenepolyamine, polyethylencamine of Formula I, and/or polyethyleneamine of Formula II. The linear TEPAN exhibits improved vacuum regenerability at room temperature as compared to the branched TEPAN, because the linear TEPAN does not bind carbon dioxide as strongly as the branched TEPAN.

An aspect of the invention provides a linear PEI-derivatized sorbent that is vacuum regenerable, captures moisture and CO₂ under ambient conditions, and releases the moisture and CO₂ under reduced pressure or flow. The sorbent comprises a substrate (such as OSU-6, styrene-divinylbenzene copolymer (S-DVB), polyalkyl ester polymer, or polymethylmethacrylate (PMMA)) derivatized with linear (PEI) or TEPAN (linear, which is preferred, or branched).

The sorbent is adapted to adsorb sorbates such as moisture (water vapor), carbon dioxide, volatile compound, and/or semi-volatile compound from air, e.g. air in an enclosed habitable space having breathable air. In some embodiments, the porous substrate is selected from the group consisting of polyalkyl ester polymer, mesoporous silica, S-DVB, and PMMA. By “derivatized” is meant that the adsorption modifier is covalently bound or non-covalently bound to the substrate, meaning it may be chemically bound to, non-chemically bound to, coated onto, and/or impregnated into said porous substrate.

The sorbent is included in a device through which the breathable air is passed, whereby the sorbent captures the sorbates from the air to form a charged sorbent. The sorbents of the invention exhibit an improved combination of adsorption and desorption of sorbates. A key aspect is the improved desorption of sorbates under conditions of mildly reduced pressure of at least 1 Torr or higher. The charged sorbent is regenerated (converted back to the original sorbent) by exposing it to pressure swing cycling regeneration, whereby vacuum is used to remove the sorbates from the sorbent.

A pressure swing regeneration cycle comprises the step of exposing sorbate-containing sorbent to a pressure swing from 4.3 psia to <1 torr over approximately two minutes. In some embodiments, the temperature inside the unit remains in the range of 60-80° F. during the regeneration cycle. The charged sorbent releases the adsorbed sorbates when the porous medium is exposed to pressure swing cycling regeneration. The charged sorbent releases at least about 97.5%, at least about 99%, at least about 99.9%, at least about 99.99%, at least about 99.999% or all of the adsorbed sorbates during said regeneration. In some embodiments, the charged sorbent quantitatively releases the adsorbed sorbates. In some embodiments, the sorbent is regenerable by pressure swing cycling for at least about 100 cycles, at least about 500 cycles, at least about 1000 cycles, at least about 5000 cycles, 10000 cycles, wherein each cycle comprises a vacuum desorption (regeneration) phase lasting about 1-10 min, about 1-8 min, about 1-6 min, about 2-5 min, about 2-4 min, or about 2-3 min, wherein the vacuum is at least about 1 Torr or higher. The vacuum desorption phase may be conducted at ambient temperatures or above.

The preferred sorbents of the invention exceed NASA's requirement in terms of demonstrating a cyclic uptake capacity greater than 2.0 g CO₂/100 g of sorbent at 2-to-3 minute half-cycle (e.g., adsorb for 2 minutes/desorb for 2 minutes) and desorbs all of the CO₂ during the reduced pressure half-cycle of a swing pressure regeneration cycle (desorption pressure of 140 Pa (approximately 1 Torr) conducted for a 2-minute half-cycle). Spacesuit requirements currently specify the following: a) for a noncyclic (non-regenerable) sorbent-CO₂ loading uptake of at least 6.0 g CO₂ per 100 g sorbent when measured at 25° C. and a CO₂ concentration of 8 mm Hg; and b) for cyclic vacuum regenerable sorbent-CO₂ loading uptake phase of at least 2.0 g CO₂ per 100 g sorbent when measured at 25° C. and a CO₂ concentration of 8 mm Hg during an uptake phase of 2-3 min followed by a desorption regeneration phase of 2-3 min. The sorbents of the invention meet or exceed the Spacesuit requirements for a cyclic vacuum regenerable sorbent.

The invention thus provides the high adsorption capacity vacuum-regenerable sorbents FPX66-PEI, FPX66-TEPAN, OSU-6-PEI, Xplo-SA9T (PMMA-TEPAN), MMPA-sorbent, and PMMA-PEI. The invention also provides devices/systems containing one or more of said sorbents and use of said sorbents and devices to remove sorbates from breathable air in a closed environment.

Another aspect of the invention provides an improved SA9T-type of resin, herein referred to as Xplo-SA9T, comprising polymethylmethacrylate (PMMA) derivatized with the polyamine adsorption modifier acrylonitrile-modified tetraethylenepentamine (TEPAN), which is a partially cyanoethylated tetraethylene pentamine (tetraethylene pentamine acrylonitrile).

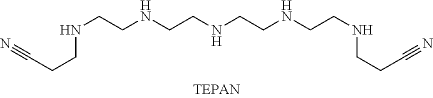 [SMILES: N#CCCNCCNCCNCCNCCNCCC#N]

The preferred particle size of the Xplo-SA9T resin (or corresponding PMMA substrate) is about 400 μm in diameter. In some embodiments, the particle size distribution of the PMMA substrate is defined as follows: effective size-0.4 mm min; uniformity coefficient-1.6 maximum; mean particle size—about 570 μm. In some embodiments, the loading percentage of TEPAN onto PMMA resin ranges from about 40-140%, about 85-130%, or is about 85-90%, about 88%, about 120-135%, about 125-130%, or about 127%.

Another aspect of the invention includes sorbents modified or derivatized with the polyamine adsorption modifier MMPA (methyl methacrylate-modified tetraethylenepentamine). The amine designated as MMPA is synthesized by a stoichiometric reaction between tetraethylenepentamine and methyl methacrylate in a neat reaction. The reaction is refluxed for at least one hour dependent on the reaction scale. Once the reaction is completed, it is verified by NMR spectroscopy, and any reaction volatiles and/or byproducts are removed in-vacuo.

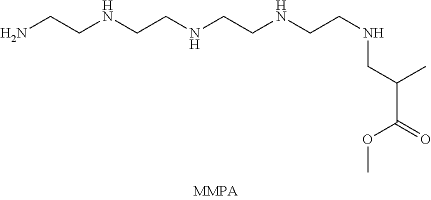 [SMILES: COC(=O)C(C)CNCCNCCNCCNCCN]

Another aspect of the invention provides sorbents modified or derivatized with a polyamine adsorption modifier polyethyleneamine of the Formula I

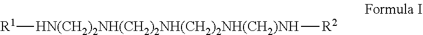

wherein:
R¹ is independently selected at each occurrence from the group consisting of hydrogen, methyl ester, alkyl, and aryl substituted alkyl;
R² independently selected at each occurrence from the group consisting of methyl ester, alkyl, and aryl substituted alkyl; and
R¹ may or may not be the same as R².

Another aspect of the invention provides sorbents modified or derivatized with a polyamine adsorption modifier polyethyleneamine of Formula II

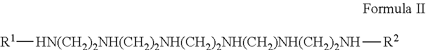

wherein:
R¹ is independently selected at each occurrence from the group consisting of hydrogen, alkylnitrile, alkyl, and aryl substituted alkyl;
R² independently selected at each occurrence from the group consisting of alkylnitrile, alkyl, and aryl substituted alkyl; and
R¹ may or may not be the same as R².

In some embodiments, the polyamine adsorption modifier of Formula I or Formula II are independently selected at each occurrence from the group consisting of

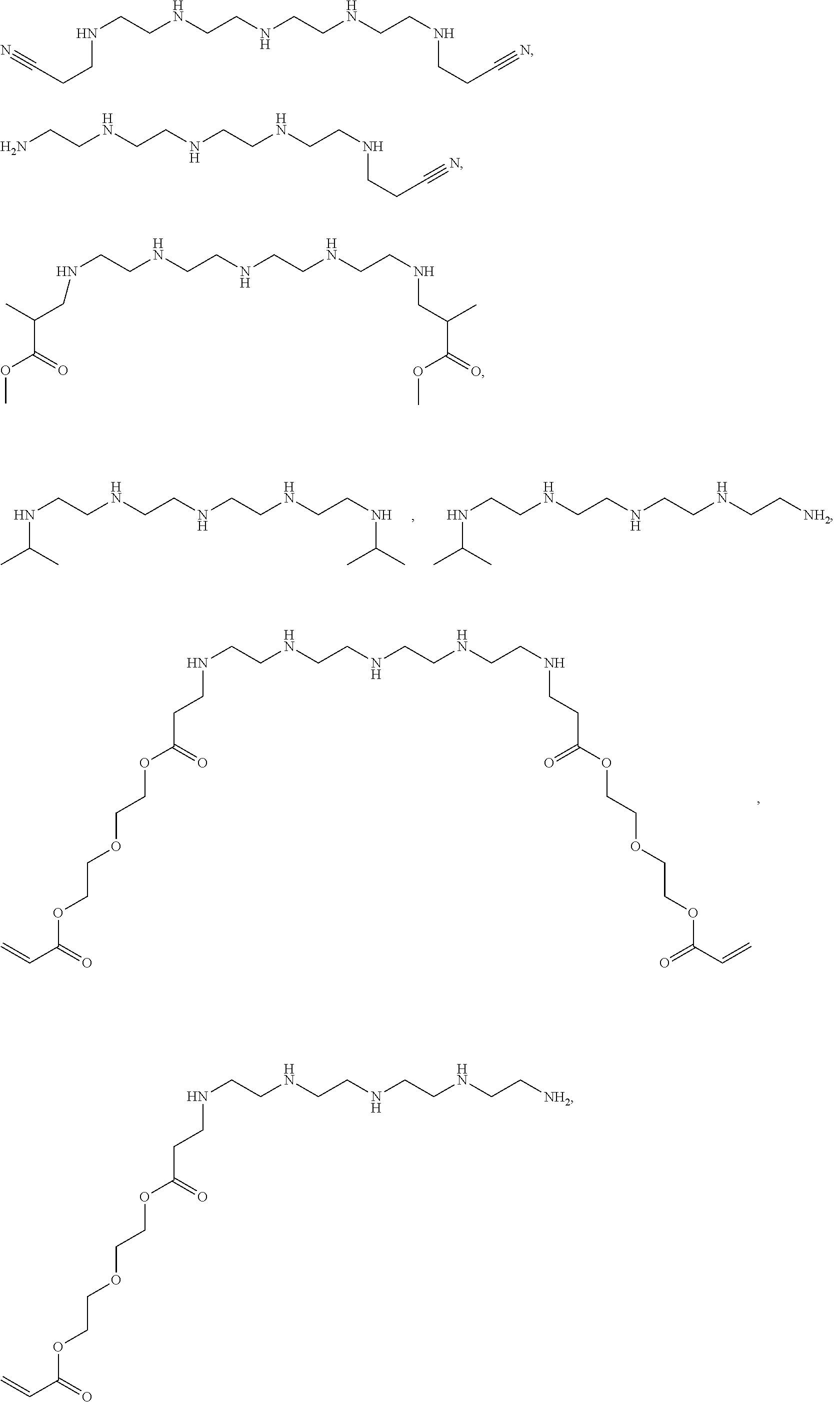

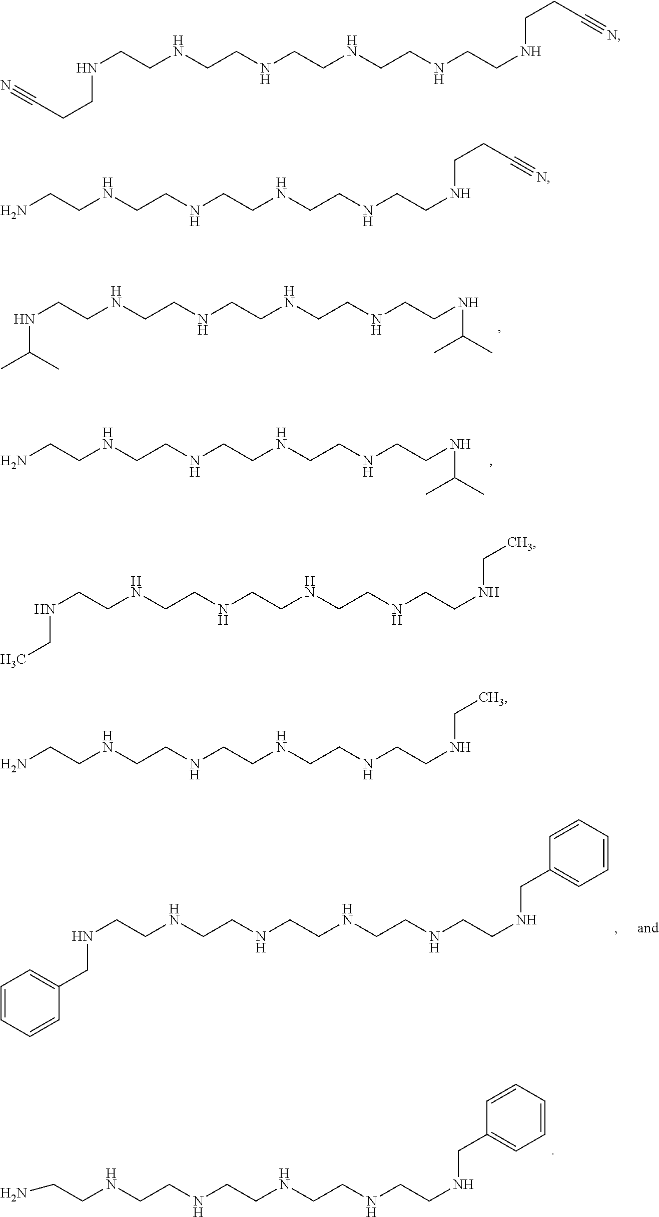

Sorbents that can be modified with the polyethyleneamines of Formula I or Formula II are selected from the group consisting of Amberlite FPX66 (macroreticuar non-functionalized cross-linked divinylbenzene polymer), Amberlite IRA400 (CAS 9002-24-8; a macroporus quaternary-amine functionalized anionic strong basic ion-exchange resin comprising Poly(divinylbenzene-co-trimethyl(vinylbenzyl) ammonium chloride), Amberlite FPA51 (an weakly basic anion exchange styrene-divinylbenzene polymer resin with a tertiary amine content of ≥85% and a total exchange capacity of ≥1.3 eq/L; particle diameter size 490-690 microns), Diaion WA21J (weakly basic polyamine anion exchange styrene-divinylbenzene polymer resin with a total exchange capacity of at least 2.0 meq/mL; mean particle size of 610 microns), Diaion HP2MGL (polymethacrylate resin, highly porous, P.R. is 240 angstroms, P.V. (pore volume) is 1.3 mL/g, surface area is 570 m²/g), Purolite PuroSorb PAD950 (nonionic polymethacrylate resin with a particle size range of 350-1200 microns), Sepabead SP700 (nonionic ethylvinylbenzene-divinylbenzene resin), and SepaBead SP70 (CAS number 9043-77-0; nonionic styrene-divinylbenzene resin), Purolite PuroSorb PAD6100 (nonionic microporous highly cross-linked polystyrene resin, Sorbtech CARIACT Q-20C (silica sorbent). In some embodiments, the preferred sorbent is Diaion HP2MGL.

In some embodiments, a) the sorbent has been sieved; b) the sorbent has an ASTM11 verified particle size in the range of about 600-1000 microns; c) the sorbent has a density in the range of about 0.2-0.6 g/mL; d) the sorbent has a water uptake capacity within 1 hour of exposure at 52% RH and at least a 100 mL/min flow rate of about 60-100 g/kg; e) the sorbent has a 0-99% CO₂ breakthrough capacity of about 0.7 mmol/g or higher; or f) a combination of any two or more of the above.

Another aspect of the invention provides another improved SA9T-type of resin, herein referred to as PMMA-PEI, comprising polymethylmethacrylate (PMMA) derivatized with linear polyethyleneimine (PEI). The preferred particle size of the PMMA-PEI resin is about 400 μm in diameter. In some embodiments, the particle size distribution of the PMMA substrate is defined as follows: effective size-0.4 mm min; uniformity coefficient-1.6 maximum; mean particle size—about 570 μm. In some embodiments, the loading percentage of PEI onto PMMA resin ranges from about 35-150%, about 40-130%, about 40-120%, about 30-50%, about 35-50%, about 40-50%, about 40-45%, about 100-150%, about 100-140%, about 100-130%, about 110-120%, or is about 43%, or about 118%.

Another aspect of the invention provides an improved FPX66 type (S-DVB) of resin, herein referred to as FPX66-PEI, comprising the substrate FPX66 resin derivatized (impregnated) with linear polyethyleneimine (PEI). In some embodiments, the loading percentage of PEI onto FPX-66 resin ranges from about 30-80%, about 35-65%, about 35-45%, about 45-55%, about 55-65%, or is about 40%, about 52%, or about 60%. Even though the about 60% loading provided higher CO₂ binding capacity (3.3 g CO₂/100 g sorbent), the about 40% loading provided acceptable CO₂ binding capacity (2.6 g CO₂/100 g sorbent) and the best vacuum regenerability, as determined by extent of CO₂ desorption. This improved sorbent substrate comprises crack-free 600-1000 μm (or 600-750 μm) diameter beads with high pore volume and surface area. The linear PEI facilitates the uptake and release of CO₂ and moisture. The sorbent can be exposed to thermal cycling (up to 110° C.), and to high flow of air, humidity and gases (CO₂ and nitrogen) at flows exceeding 2 L/min; and vacuum cycling at 140 Pa (approximately 1 Torr) for multiples cycles. The sorbent remains mechanically robust and does not exhibit any powdering under such conditions.

In some embodiments, the FPX-66-PEI sorbent of the invention provides regenerative CO₂ and humidity removal via a pressure swing regeneration cycling that desorbs the gases (vapors, compounds) upon exposure to vacuum and requires little to no maintenance by a user. The sorbent exhibits superior stability, higher capacities for water and carbon dioxide, and faster kinetics for uptake and release than prior art sorbents used in Rapid Cycle Amine (RCA) technology relative to known state of the art. As a result, use of this sorbent results in reduction in power draw, volume envelope, and mass while maintaining the current CO₂ and humidity removal capacity and minimizing or eliminating requirements for maintenance of the sorbent, e.g. such as by an astronaut.

In some embodiments, the sorbent is embedded (dispersed) within conductive porous metal foam.

The device of the invention can be adapted for use in a breathable air treatment device. It is only necessary that the device permit contact between the sorbent(s) and the breathable air passed (forced) through the device. In some embodiments, the device is a trace contamination control (TCC) system. The sorbent can be contained in one or more TCC units. The sorbents are particularly suitable for use in RCA units within NASA's Exploration Extravehicular Mobility Unit (xEMU).

Another aspect of the invention provides an improved OSU-6 type of sorbent, herein referred to as OSU-6-PEI, comprising the substrate OSU-6 sorbent derivatized (impregnated) with linear polyethyleneimine (PEI). The OSU-6 sorbent is an MCM-41 type sorbent as defined herein. In some embodiments, the loading percentage of PEI onto OSU-6 sorbent ranges from about 30-70%, about 35-65%, about 35-45%, about 45-55%, about 55-65%, or is about 40%, about 52%, or about 60%. Even though the about 60% loading provided higher CO₂ binding capacity (3.3 g CO₂/100 g sorbent), the about 40% loading provided acceptable CO₂ binding capacity (2.6 g CO₂/100 g sorbent) and the best vacuum regenerability, as determined by extent of CO₂ desorption. The OSU-6-PEI sorbent is capable of capturing and releasing low to high amounts of one or more volatile compound(s) (VC) or semi-volatile compound(s) (SVC) present in a closed habitable gaseous environment. The OSU-6-PEI sorbent is regenerable by pressure swing cycling. The chain length (expressed by molecular weight) of the PEI ranged from about 800-2000 for the branched PEI and about 2000-3000 or about 2500 (preferred) for the linear PEI.

An aspect of the invention provides a TCC system (xPLSS) comprising a mesoporous silica sorbent (OSU-6-PEI) for use in nanoconfinement technology as a viable material to meet NASA's technical requirements of a vacuum-regenerable sorbent that can be employed for removal of trace contaminants (carbon monoxide, ammonia, formaldehyde, methyl mercaptan, organophosphates, nitrogenated organics, chlorocarbons, ketones, aldehydes, aromatics, organic acids, alkanes, alkenes, alkynes, alcohols, freons, siloxanes, nitramines, pyrethroids, polychlorinated biphenyls, nitroaromatics, pesticides, fluorocarbons, and polynuclear aromatic hydrocarbons, acetaldehyde, acetic acid, acetone, acrolein, 1-butanol, ethanol, furan, hexamethylcyclotrisiloxane, methane, methanol, methyl ethyl ketone, toluene, and/or trimethyl silanol) from the air of an enclosed environment, e.g. an Extra-Vehicular Mobility Unit (xEMU).

Another aspect of the invention provides a TCC system (xPLSS) comprising a sorbent derivatized with hydrothermally stable amine groups (e.g. polyamine adsorption modifier) to enhance its uptake of carbon dioxide and water. Preferred embodiments of the sorbent (FPX-66-PEI) provide substantially less outgassing than prior art sorbent. The FPX-66-PEI provides high capacity for water and carbon dioxide, provides very fast uptake and release kinetics for water and carbon dioxide, and is completely (100%) regenerable under spacesuit's prescribed operating conditions. Reduced outgassing significantly increases the lifetime of a trace contaminant control (TCC) unit containing the sorbent and reduces the mass of such unit because of the lower mass of sorbent required as compared to prior art sorbents. This new sorbent not only addresses the needs of the spacesuit, but also has important terrestrial applications. Being easily regenerable, the sorbent can replace prior art liquid amines for industrial CO₂ capture. The improved sorbent is thermally and hydrothermally stable.

A device according to the invention, e.g. TCC system (xPLSS), comprises: a) one or more containers comprising one or more vacuum regenerable sorbents contained therein; and b) one or more pumps to force air through said one or more containers. During use, air passes through the sorbent(s) which remove compound(s) from the air to form purified (cleaned) respirable air which exits the container. The TCC system further comprises a vacuum source and associated valve, wherein the vacuum source may comprise a vacuum pump and/or simply a conduit to a reduced pressure atmosphere exterior to the container. The reduced pressure environment can be atmospheric space, such as the atmosphere outside a space vehicle, spacecraft, or astronaut suit.

A container comprises a) a housing, at least one entry port, and at least one exit port; and b) one or more chambers, defined by said housing, containing said one or more vacuum regenerable sorbents. In some embodiments, the housing comprises a) a first end comprising said entry port; b) a second end comprising said exit port; and c) a body. The housing and ends define one or more chambers within which sorbent is disposed. The first and second ends are, independently upon each occurrence, removable from or permanent with the body. In some embodiments, at least one of first or second ends is removable. The entry and exit ports are, independently upon each occurrence, flanged or not flanged. In some embodiments, sorbent is contained within a sorbent holder comprising an air permeable material. Whenever an air permeable material is required, exemplary materials include mesh, fabric, porous foam, porous plate, perforated plated, porous rubber, or other such materials.

The container is constructed of material(s) suitable for operating under elevated pressure (above ambient pressure) through to reduced pressure (below ambient pressure). The materials will be stable toward pressure swing cycling regeneration.

In some embodiments, the container further comprises one or more of the following: a) at least one sorbent holder disposed within said one or chambers; b) a first particle filter conductively associated with said entry port; c) a second particle filter conductively associated with said exit port; d) a first support plate disposed between said entry port and said at least one sorbent holder; e) a second support plate disposed between said exit port and said at least one sorbent holder; f) one or more fasteners; and g) one or more seals. In some embodiments, a particle filter is an air filter or any medium suitable for removing particles from air. The components are optionally arranged in stacked formation such that air flows through them sequentially.

In some embodiments, the sorbent holder is replaceable, whereby expired sorbent may be replaced with usable sorbent. In some embodiments, the charge of sorbent within the sorbent holder is replaceable. In some embodiments, a container comprises two or more sorbent holders, wherein said sorbent holders may be present in stacked or side-by-side arrangement. In some embodiments, the sorbent holder is independently selected upon each occurrence from a canister, cartridge, tube, wafer, pouch, sphere, rod, or bag. In some embodiments, said sorbent holder comprises PTFE (polytetrafluoroethylene), polypropylene, PTFE-coated wire, and/or other material adapted for making a breathable mesh.

Sorbent included within the container or sorbent holder is present, independently upon each occurrence, as a single type of sorbent or a combination of two or more sorbents. Said combination may be a) a heterogeneous mixture of sorbents; b) a homogeneous mixture of sorbents; c) layers of the sorbents in stacked arrangement; d) layers of the sorbents in laminar arrangement; and/or e) layers of the sorbents in side-by-side arrangement. The sorbent may be present in powder, granulate, bead, pellet, or other such form.

In some embodiments, a container or device of the invention comprises a combination of a) OSU-6 and FPX66-PEI (linear), wherein the sorbents are provided in separate beds (separate containers) or in the same bed (same container-mixed or layered); b) a known sorbent, e.g. RCA (for CO₂ and humidity removal), and one or more sorbents of the invention; c) a known sorbent, e.g. RCA (for CO₂ and humidity removal), and one or more sorbents of the invention that removes volatile and semi volatile compounds.

In some embodiments, a container or device of the invention comprises a) a combination of two different sorbents; b) a single sorbent; c) a combination of water-adsorbing sorbent (a desiccant sorbent or desiccating sorbent) and CO₂-adsorbing sorbent; or d) a combination of three or more different sorbents. In some embodiments, the different sorbents are separated by a physical barrier, e.g. glass wool, metal or plastic mesh, separate cartridges, etc., so as to allow for the separate recapture of water independent of the recapture of CO₂.

A TCC system comprising two or more containers may have the containers arranged in stacked arrangement, side-by-side arrangement, or a combination thereof. The device may be constructed such that each container can undergo pressure swing cycling regeneration independently or such that plural containers undergo pressure swing cycling regeneration sequentially, simultaneously, or in an overlapping manner. In some embodiments, the TCC device comprises at least a first container and a second container in conductively parallel arrangement whereby during operation of the device one of the containers treats (decontaminates) air while the other container undergoes pressure swing cycling regeneration (thereby removing contaminants from the respective sorbent).

Another aspect of the invention provides a sorbent testing system used to evaluate the adsorption capacity and regenerability of the sorbents of the invention included within a TCC. The system is capable of conducting pressure swing cycling regeneration on the sorbents. The system is particularly suitable for testing and evaluating water (moisture) and carbon dioxide (CO₂) adsorption and desorption. The system comprises the following conductively engaged components: a) gas source; b) mixed-gas tank; c) sub-atmospheric regulator; and d) sub-atmospheric testing loop. The gas source provides humidified air and carbon dioxide to the mixed-gas tank. The sub-atmospheric regulator controls the pressure within the tank. The sub-atmospheric testing loop forces the mixed gas through the TCC unit containing sorbent being tested and into a gas-testing loop, wherein the content of water and carbon dioxide in the mixed gas are determined.

More specifically, the system comprises the following conductively engaged components: a) gas source comprising: 1) contaminant source and associated first flow controller and valve; 2) humidified air source and associated first sub-atmospheric regulator, second flow controller, and valve; 3) first mixing valve downstream of the first and second flow controllers; and 4) second sub-atmospheric regulator downstream of the first mixing valve; b) downstream of the first and second sub-atmospheric regulators, a mixed-gas tank and associated relative humidity (RH) gauge and first pressure gauge; c) sub-atmospheric regulator downstream of the tank comprising, in the following sequence, a sub-atmospheric back regulator, flow-reducing valve, and vacuum pump; and d) sub-atmospheric testing loop, conductively engaged with the tank, comprising in the following sequence 1) sealed blower (pump); 2) splitter valve directing gas to a bypass line and a test-article line, said bypass line having a regulator, and said test-article line having a pressure gauge upstream of a TCC unit and a pressure gauge downstream of the TCC unit; 4) mixing valve downstream of the bypass line and test-article line and upstream of a gas-analysis loop. The system optionally further comprises in-line sensors, in particular conductively between the sealed blower and the splitter valve. The contaminant can be CO₂, volatile compound, semi-volatile compound, or a combination thereof.

The sorbent, container, testing system, and/or TCC (xPLSS) may be included in a spacecraft, watercraft, land craft, or space suit (xEMU), e.g.deep-seaa diving gear, expeditionary space vehicles, transport vehicles such as those used in lunar or extraterrestrial applications.

The invention includes all combinations of the embodiments, sub-embodiments and aspects disclosed herein. Accordingly, the invention includes the embodiments and aspects specifically disclosed, broadly disclosed, or narrowly disclosed herein, as well as combinations thereof and sub-combinations of the individual elements of said embodiments and aspects.

Other features, advantages and embodiments of the invention will become apparent to those skilled in the art by the following description, accompanying examples.

### BRIEF DESCRIPTION OF THE FIGURES

The following figures form part of the present description and describe exemplary embodiments of the claimed invention. These drawings are not necessarily drawn to scale and are instead intended to illustrate the general principles of the invention as further described herein. Although specific embodiments are described below with specific reference to the drawings provided, other embodiments are possible without deviating from the spirit and scope of the present invention. The skilled artisan will, in light of these figures and the description herein, be able to practice the invention without undue experimentation.

FIG. 1A depicts a perspective view of an exemplary container (1) comprising a body (3), a first end cap (2) having a flanged entry port (5), and a second end cap (4) having an exit port (not depicted).

FIG. 1B depicts an exploded view of the container (1) of FIG. 1A. Disposed within the container are filters (7 and 10), porous or perforated support plates (8 and 11), and sorbent holder (9). The exit port (6) is depicted in the end cap (4).

FIG. 2A depicts a perspective view of an exemplary container (15) comprising a body (17), a first end cap (16) having a non-flanged entry port (19), and a second end cap (18) having an exit port (not depicted).

FIG. 2B depicts an exploded view of the container (15) of FIG. 2A. Disposed within the container are filters (22 and 24), support plates (21 and 25), and sorbent holder (23). The exit port (20) is depicted in the end cap (18).

FIG. 3A depicts a perspective view of an exemplary container (30) comprising a body (32), a first end cap (31) having a flanged entry port (34), a second end cap (33) having an exit port (not depicted), and plural fasteners (35).

FIG. 3B depicts an exploded view of the container (30) of FIG. 3A. Disposed within the container are filters (39 and 41), support plates (38 and 42), sorbent holder (40), and seals (37 and 43). The exit port (36) is depicted in the end cap (33).

FIG. 4 depicts a sub-atmospheric recirculating testing system for determining the moisture and carbon dioxide content of gas that has been passed through a TCC unit comprising sorbent of the invention.

FIG. 5 depicts a generalized schematic of an alternate embodiment of the sub-atmospheric recirculating testing system.

FIG. 6 depicts a sectional side view of a container comprising plural sorbent holders (two different types) in stacked arrangement. A first type of sorbent adsorbs water and carbon dioxide, and a second type of sorbent adsorbs volatile and semi-volatile compounds. Air is forced through the container in the direction of the arrow.

FIG. 7 depicts a sectional side view of a container comprising plural sorbent holders (two different types) in side-by-side arrangement. A first type of sorbent adsorbs water and carbon dioxide, and a second type of sorbent adsorbs volatile and semi-volatile compounds. Air is forced through the container in the direction of the arrow.

FIG. 8 depicts a sectional side view of a container comprising a sorbent holder containing a mixture of three different types of sorbents: OSU-6, derivatized OSU-6 (e.g. OSU-6-PEI), and FPX66-PEI. Air is forced through the container in the direction of the arrow, and sorbates are adsorbed onto the sorbents.

FIG. 9 depicts CO₂ breakthrough curves for various sorbents at a CO₂ concentration of 500 ppm, sorbent masses of 50-70 mg, column length of 14 mm, and gas flow rate of 100 mL/min.

FIG. 10 depicts graphs of the output of CO₂ during corresponding sequential cycles of air treatment (FIG. 10, upper) and vacuum regeneration (FIG. 10, lower) for the FPX66-PEI sorbent.

FIG. 11 depicts a graph of the output of CO₂ during corresponding sequential cycles of air treatment and vacuum regeneration during a 250 min test period for the known sorbent SYLOBEAD MS 544C.

FIG. 12 depicts a top-plan view of a pressure swing bed recycling unit as an exemplary TCC.

FIG. 13 depicts a schematic of a TCC test bed system.

FIG. 14 depicts a schematic of a gas source subsystem employed as part of the test bed system.

FIG. 15 depicts a schematic of a gas sampling subsystem employed as part of the test bed system.

FIG. 16 depicts a partial exploded sectional side view of an alternate container of the invention.

FIG. 17 depicts the chemical structure of some of the TEPANs that can be used to derivatize the sorbent.

FIG. 18 depicts a spacecraft, watercraft (submarine), Extra-Vehicular Mobility Unit (xEMU, space suit), and land craft (lunar module) equipped with an Exploration Portable Life Support Subsystem (xPLSS), sorbent, container, air treatment system, and/or air testing system according to the invention.

FIG. 19 depicts a graph of the vacuum regeneration of Xplo-SA9T and MMPA-sorbent (MMPA-Diaion HP2MGL)

FIG. 20 depicts a graph of the CO₂ breakthrough capacity after regeneration of Xplo-SA9T with positive nitrogen flow at 60° C. for 2 hours.

FIG. 21 depicts a graph of the regeneration of Xplo-SA9T on the CO₂ breakthrough rig by positive pressure.

FIG. 22 depicts a graph of the vacuum regeneration of Xplo-SA9T post-full breakthrough.

### DETAILED DESCRIPTION OF THE INVENTION

The invention provides improved vacuum regenerable sorbents, related trace contamination control systems, and their related uses. The invention also provides a sub-atmospheric gas recycling testing system for testing the sorbents of the invention.

The sorbent and devices of the invention provide numerous improvements over known sorbents and devices: a) improved uptake (adsorption) rates; b) improved release rates; c) complete regenerability under slight vacuum; c) reduced off-gassing of contaminants (e.g. ammonia or decomposition products or byproducts) back into the decontaminated air.

As used herein, the term “OSU-6” is taken to mean non-functionalized (underivatized) mesoporous silica, which is used as a porous substrate to the corresponding derivatized sorbent. As used herein, the term “non-functionalized mesoporous silica” (or “non-functionalized sorbent”) refers to mesoporous silica that has not been functionalized with one or adsorption modifiers. The mesoporous silica of the MCM-41 (hexagonal tubular pores structure) types exhibits a tertiary or quaternary structure characterized by stacked layers of hexagonally-shaped parallel tubes. The OSU-6 is used as a substrate to prepare derivatized OSU-6 sorbent of the invention.

Embodiments of the invention include those wherein the preferred OSU-6 substrate is an improved grade of MCM-41 type mesoporous silica that possesses one or more, and preferably a combination of two or more, of the following properties:

| Property | Minimum value | | Range of values |
|---|---|---|---|
| Linear formula | SiO₂ polymer | | |
| Form | powder | | |
| Pore structure | Hexagonal tubes | | |
| Pore size | >2 | nm | about 2 to about 30 nm |
| (diameter) | | | about 2 to about 15 nm |
| | | | about 5 to about 10 nm |
| | | | average about 8 nm |
| Pore volume | >0.5 | cm³/g | about 0.5 to about 2.0 cm³/g |
| | | | about 1.0 to about 2.0 cm³/g |
| | | | about 1.2 to about 1.7 cm³/g |
| | | | average about 0.5-0.7 ml/g |
| Surface area | at least 600 m²/g and | | about 600 to about 1000 m²/g |
| | up to 900 m²/g | | about 700 to about 1000 m²/g |
| | | | about 800 to about 1000 m²/g |
| | | | greater than about 700 m²/g |
| Channel wall | >2 | nm | about 2 to about 5 nm |
| thickness | | | about 2 to about 4 nm |
| | | | about 2 to about 3 nm |

The grade of MCM-41 mesoporous silica which may be used as the substrate for the derivatized OSU-6 sorbents of the invention exhibits a large pore size, a high pore volume, and, when compared to conventional grades of MCM-41, exhibits thicker channel walls, higher thermal stability (up to 950° C.), and higher hydrothermal stability (which is expressed in terms of changes to sorbent porosity after treatment in boiling water for more than 25 hours. In some embodiments, the mesoporous silica of the invention exhibits no, or less than 10%, or less than 5% change in sorbent porosity after treatment in boiling water for more than 25 hours. Preferred embodiments of the mesoporous silica are prepared according to the procedure of Example 1.

X-ray diffraction analysis of the OSU-6 depicts three well-resolved diffraction peaks in the region of 2Θ=1-5°, which can be indexed to the (100), (110) and (200) diffractions, characteristic of the formation of well-arranged hexagonal mesostructures. The SEM (scanning electron microscopy) image of the OSU-6 shows a narrow particle size distribution and well-defined spherical particles. The mean average particle size of the OSU-6 was in the range of about 250 nm to about 1500 nm in diameter. The TEM (transmission electron microscopy) image of the OSU-6 shows the presence of well-defined pore channels with diameters of about 5 nm (about 2 to about 30 nm) and wall thickness of about 2 nm about 1 to about 5 nm) in the particles.

The FPX66 resin is a microporous, macroreticular, non-functionalized resin comprised of styrene-divinylbenzene copolymer, which may be crosslinked. The FPX66 substrate is readily commercially available. A preferred embodiment comprises AMBERLITE FPX-66 (DuPont, Wilmington, DE) having a particle size in the range of 600-750 μm. FPX66 is a macroporous crosslinked nonfunctionalized aromatic polymer characterized as follows: surface area—about 700 m²/g; total pore volume—about 1.4 cc/g; water retention capacity—about 60-68%; particle diameter—about 600-750 μm with a uniformity coefficient of ≤1.70, ≤3.0% of particles <300 μm, ≤5.0% of particles >1180 μm; particle density about 1.105-1.025 g/mL.

FPX66-PEI according to the invention comprised linear-PEI loadings of about 30%, about 35%, about 40%, 41%, about 45%, about 50%, 52%, about 60%, 61%, 68.9%, 75%, 83%, and 118%. Preferred ranges for the percentage of PEI loading include about 30-130%, about 30-100%, about 30-85%, about 30-65%, about 30-55%, or about 35-50%. FPX66-TEPAN according to the invention was derivatized with TEPAN loadings of 41%, 83%. Preferred ranges for the percentage of TEPAN loading include about 30-130%, about 30-100%, about 30-85%, about 30-65%, about 30-55%, or about 35-50%. The loading percentage is determined as following: (weight of derivatized sorbent/weight of substrate)*100.

In some embodiments, the PMMA substrate resin is a porous crosslinked methacrylate polymer characterized as follows: surface area—about 570 m2/g; total pore volume—about 1.3 cc/g; pore radius—about 240 angstroms; water retention capacity—about 55-65%; effective size—about 0.40 mm minimum; mean particle diameter—about 570 μm with a uniformity coefficient of ≤1.60, ≤1.0% of particles <355 μm; particle density about 1.09 g/mL SA9T and Mistubishi Diaion HP2MGL are suitable commercial sources for the PMMA resin. Alternatively, it may be prepared as described herein. Xplo-SA9T and PMMA-PEI are prepared by functionalization of the PMMA substrate.

The device (apparatus, system) of the invention comprises at least one container having at least one entry port and at least one exit port. A charge of sorbent is included within the container and during use, forced air, containing compounds to be removed, enters the container through the entry port, passes through the sorbent (whereby the compounds are adsorbed onto the sorbent), and exits through the exit port as cleaned (treated) air. The invention includes any such container adapted for such operation.

One or more sorbents are included in a container through which contaminated air is forced during use.

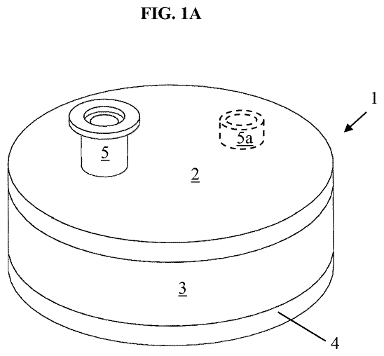

FIG. 1A depicts a perspective view of an exemplary container (1) comprising a body (3), a first end cap (2) having a flanged entry port (5), and a second end cap (4) having an exit port (not depicted). Although depicted in cylindrical format, the container can be shaped as needed. One or more additional entry ports (5a) and/or exit ports (not depicted) can be included. The end caps are independently upon each occurrence a) removable or permanent; b) integral with, engaged with, or affixed to the body; and/or c) flanged or non-flanged.

FIG. 1B depicts an exploded view of the container (1) of FIG. 1A. Disposed within the container are particle filters (7 and 10; e.g. mesh, web, wool, glass wool, or fiber filters), support plates (8 and 11), and sorbent holder (9). The exit port (6) is depicted in the end cap (4). The components within the container are in stacked arrangement. Air to be treated enters through the entry port (5), passes through the particle filter (7), then through the support plate (8), then through the sorbent holder (9), then through the particle filter (10), then through the support plate (11) and exits through the exit port (6). The arrangement of the filter and support plates can be reversed. In preferred embodiments, the sorbent holder is disposed within two air filters and two support plates.

The size and shape of the sorbent holder included in the container may be altered as needed according to the target pressure drop across the top to bottom of the corresponding packed bed of granular sorbent. The packing density of the granular sorbent may also be optimized as needed. The pressure drop should be minimized while simultaneously providing enough sorbent media for the adequate filtration of trace contaminants. A target pressure drop maximum would be at least (not less than) 6 CFM at 220 Torr. The TCC should have a maximum pressure drop across the unit of 0.011 psia (specified as 0.3 in-H₂O in Reference 3) or 0.6 Torr. The unit should be able to filter out particles greater 25 μm that might be generated externally or by sorbent dusting. The pressure-drop across different TCC configurations is assessed by pressure gauges placed on both sides of the filter housing. The sorbents of the invention meet the current specifications of the spacesuit: the TCC should contain an operating or ventilation loop with a pressure of 220 Torr and maximum pressure drop of 0.6 Torr across the unit, specified as 0.3 in-H₂O.

When the Micronel blower described herein, 6 ACFM flow could be maintained within the TCC loop. The pressure drop between the two pressure gauges was measured to be 3±2 Torr at 6 CFM at atm pressure when a KF2-KF25 tube was positioned in place of the KF25 to KF16 adaptors and the TCC. It is believed that this drop is due to the diameter change between the KF25 Tubing and the KF25-KF25 adaptor that holds the second pressure gauge and has reduced diameter. When the KF25 to KF16 adaptors and TCC housing (without the sorbent chamber) were installed, a pressure drop of 6±2 Torr was observed. Pressure drops with the inclusion of the sorbent chamber were indistinguishable from the drop without the sorbent chamber installed. SOLIDWORKS Flow Simulations indicate that most of the measured pressure drop is at the KF-16 connector of the TCC housing. This smaller diameter of the inlet of the TCC housing was chosen for compatibility with existing test infrastructure at NASA. A TCC housing with KF25 flange and 1.9 cm ID entrance diameter was also tested. When this housing and the sorbent chamber were installed, the pressure was indistinguishable from the drop measured with the KF2-KF25 tube in place of the TCC. With the sorbent chamber filled with 1 mm silica beads, an additional pressure drop of 1 Torr was recorded.

In some embodiments, the sorbent chamber was closed at each end using polypropylene mesh fabric as filter. Both a 400 μm (40 mesh) and a 350 μm (45 mesh) fabric provided significant flowthrough and capture of the sorbent. For filtering particles greater than 25 μm, three different glass filter paper materials were tested in case the sorbent could not capture these particles.

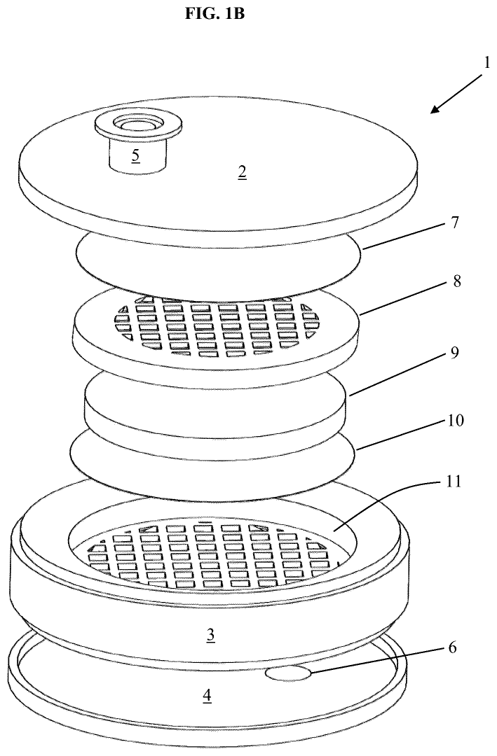

FIG. 2A depicts a perspective view of an exemplary container (15) comprising a body (17), a first end cap (16) having a non-flanged entry port (19), and a second end cap (18) having an exit port (not depicted).

FIG. 2B depicts an exploded view of the container (15) of FIG. 2A. Disposed within the container are filters (22 and 24), support plates (21 and 25), and sorbent holder (23). The exit port (20) is depicted in the end cap (18). The components within the container are in stacked arrangement. Air to be treated enters through the entry port (19), passes through the support plate (21), then through the particle filter (22), then then through the sorbent holder (23), then through the particle filter (24), then through the support plate (25) and exits through the exit port (20). The arrangement of the filter and support plates can be reversed. In preferred embodiments, the sorbent holder is disposed within two air filters and two support plates.

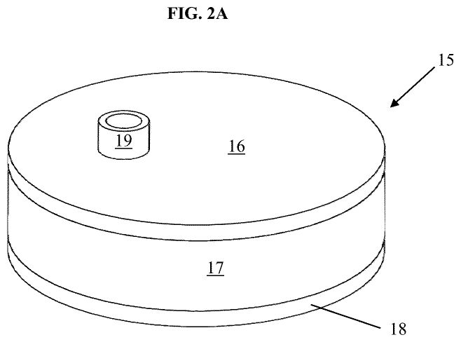

FIG. 3A depicts a perspective view of an exemplary container (30) comprising a body (32), a first end cap (31) having a flanged entry port (34), a second end cap (33) having an exit port (not depicted), and plural fasteners (35). One or more fasteners can be used to secure one or more of the end caps to the body. In this particular embodiment, the fasteners comprise bolts and nuts, latches, or other such means, e.g. mating fastening means between endcap and body: mating threaded joint, mating snap-fit joint, mating compression fit joint.

FIG. 3B depicts an exploded view of the container (30) of FIG. 3A. Disposed within the container are filters (39 and 41), support plates (38 and 42), sorbent holder (40), and scals (37 and 43). The exit port (36) is depicted in the end cap (33). The components within the container are in stacked arrangement. Air to be treated enters through the entry port (34), passes through the support plate (38), then through the particle filter (39), then then through the sorbent holder (40), then through the particle filter (41), then through the support plate (42) and exits through the exit port (36). The container further comprises a seal (37) disposed between the first end cap and the body and a seal (43) between the second end cap and the body. The arrangement of the filter and support plates can be reversed. In preferred embodiments, the sorbent holder is disposed within two air filters and two support plates.

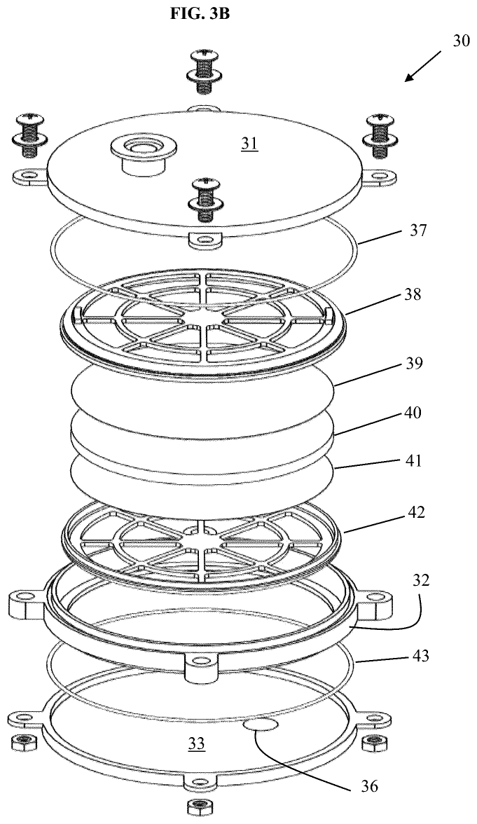

FIG. 6 depicts a container comprising plural sorbent holders (two different types of sorbents) in stacked arrangement. Although not depicted in this figure, air filters and/or structural plates may be disposed between, before and/or after the sorbent holders as needed. A first type of sorbent adsorbs water and carbon dioxide, and a second type of sorbent adsorbs volatile and semi-volatile compounds. Air is forced through the container in the direction of the arrow.

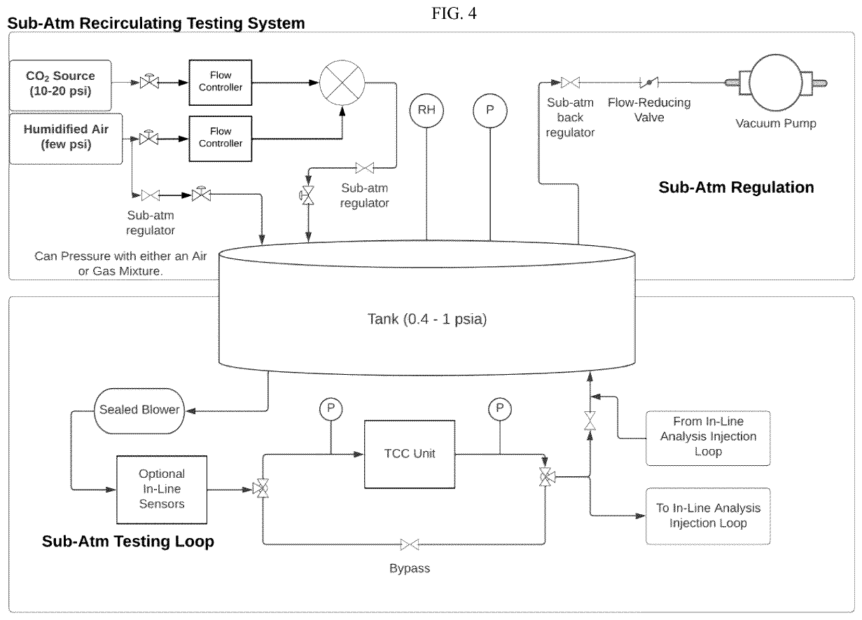

FIG. 7 depicts a container comprising plural sorbent holders (two different types) in side-by-side arrangement. Although not depicted in this figure, air filters and/or structural plates may be disposed between, before and/or after the sorbent holders as needed. A first type of sorbent adsorbs water and carbon dioxide, and a second type of sorbent adsorbs volatile and semi-volatile compounds. Air is forced through the container in the direction of the arrow.

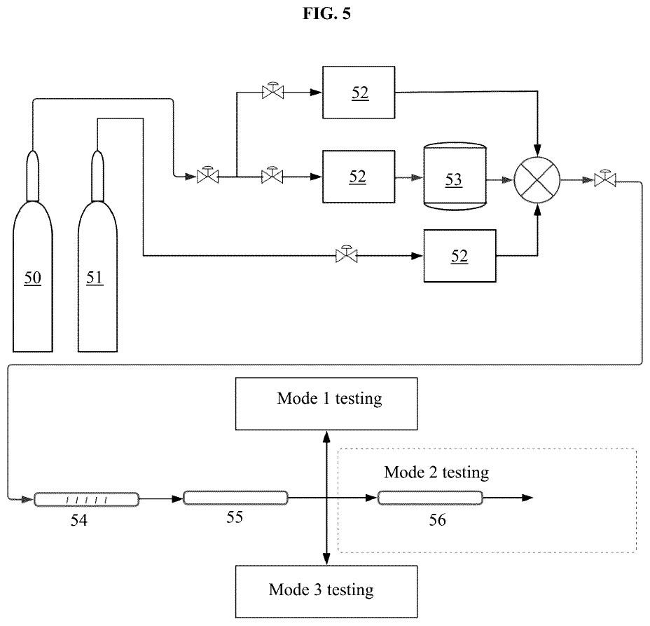

FIG. 8 depicts a container comprising a sorbent holder containing a mixture of three different types of sorbents. Air is forced through the container in the direction of the arrow and sorbates are adsorbed onto the sorbents. The mixture can be homogenous or heterogeneous. In this particular embodiment, a first sorbent primarily adsorbs water and carbon dioxide, a second sorbent primarily adsorbs at least one volatile or semi-volatile compound, and a third sorbent primarily adsorbs at least one other volatile or other semi-volatile compound. For example, a container or device of the invention may comprise a combination of a) non-derivatized OSU-6, functionalized OSU-6, and functionalized OSU-6; b) OSU-6, derivatized OSU-6, and FPX66-PEI.

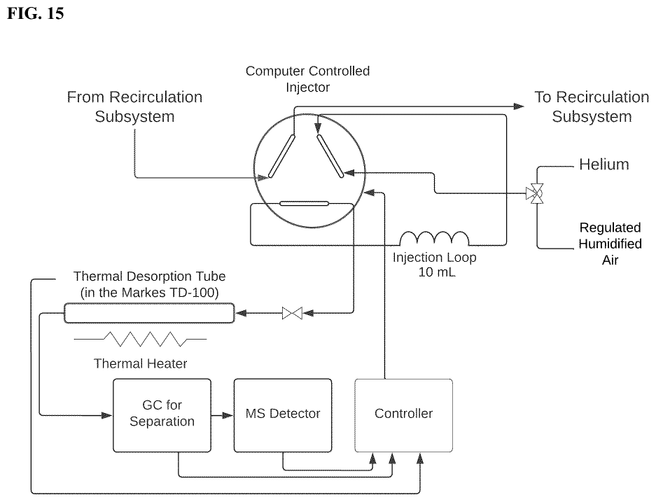

FIG. 16 depicts a partial exploded sectional side view of an alternate container comprising opposing removable end caps attached to a tubular body, within which is disposed a bed of particulate sorbent interposed mesh filters. Such container can be used in the testing system or device of the invention.

Whenever two or more different sorbents are included in the container or device, they can be present as follows: a) at least one sorbent according to the invention and at least one sorbent not according to the invention; b) a first sorbent according to the invention and a second sorbent according to the invention; c) a first sorbent according to the invention, a second sorbent according to the invention, a third sorbent not according to the invention. For example, a container or device of the invention may comprise a combination of a) non-derivatized OSU-6, first functionalized OSU-6, and second functionalized OSU-6; b) OSU-6, derivatized OSU-6, and FPX66-PEI.

In some embodiments, a Trace Contamination Control (TCC) system is a component in the oxygen ventilation loop of the Exploration Portable Life Support System (xPLSS) that removes contaminants generated by the crewmembers' metabolic processes. A recirculating test bed that mimics the environment within the xPLSS, by providing concentrations of the trace contaminant analytes at the operating temperature, humidity, pressure and flow rates of the xPLSS, was constructed. The system uses quick connect flanges and a bypass loop to allow rapid removal and replacement of sorbent beds without having to purge the trace contaminant gas stream. In addition, two minutes or longer pressure swing cycles across the TCC sorbent bed can be programmed. Contaminant removal efficiency across the sorbent beds is quantified by periodically measuring gas concentrations in the circulating stream using an automated sampling loop which incorporates a combination of real-time sensors and a vapor capture system connected to a thermal desorption unit combined with a gas chromatograph/mass spectrometer to separate and analyze contaminants for near real-time quantification. By monitoring the decrease in contaminant contents with time, the sorption capacity and rate constant of the evaluated sorbent media can be determined and compared.

The invention provides a sub-atmospheric recirculating testing system for determining the content of one or more compounds in air (gas) that has passed through a container or device of the invention. The testing system is intended for use in evaluating the adsorption and desorption of sorbates to and from, respectively, a sorbent. In general, it comprises one or more gas sources that feed gas into a tank to form a mixed gas. A testing loop then receives mixed gas from the tank and returns the mixed gas to the tank. The mixed gas passes from the tank through a blower and then to a valve that directs mixed gas to a TCC unit and/or a bypass line. Mixed gas exiting the TCC unit and/or bypass line is conducted to another valve that directs the mixed gas to an in-line analysis loop, which ultimately directs analyzed gas back to the tank.

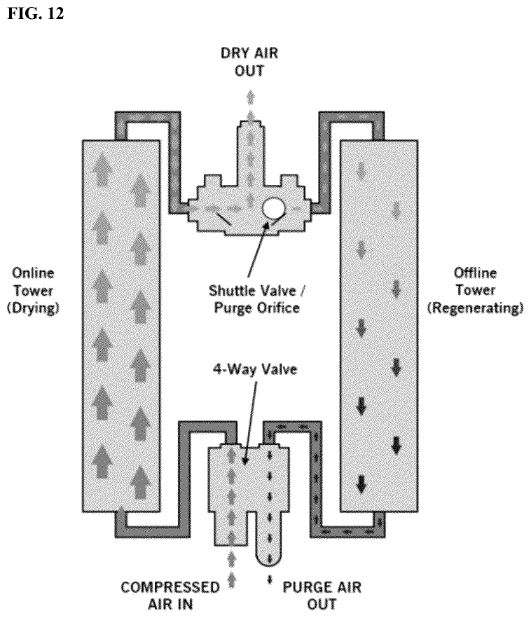

FIG. 13 depicts a schematic (block diagram) of a TCC test bed system according to the invention. There are four core subsystems in the testing apparatus. The main subsystem is the sub-atmospheric recirculation loop, including a tank, blower, and the TCC and bypass loops. The second subsystem provides a source of humidified air to maintain a desired relative humidity level and pressure in the recirculation loop. It also includes a gas mixture generation system that can produce single or multi-component analyte vapor streams at known concentrations. The third subsystem is the automated gas sampler that collects samples (e.g. 10 mL) from the recirculation loop that are then used to determine the gas phase concentrations of the analytes by thermal desorption (TD) followed by gas chromatography/mass spectrometry (GC/MS). The final component is a sub-atmospheric gas regeneration subsystem that facilitates the continuous pressure swing loop that is representative of the xPLSS. The apparatus is controlled by an Arduino microcontroller with a custom board that controls the blower speed and valves and reads the temperature, relative humidity and pressure sensors. The microcontroller also supports the sampling subsystem and its interface to the TD and MS/GC units along with the regeneration subsystem. This microcontroller is connected to a personal computer with a graphical interface for higher level monitoring, logging, and control.

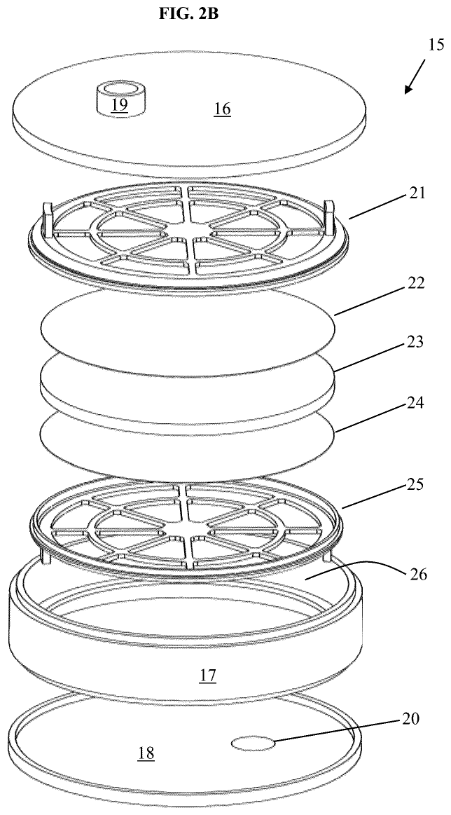

FIG. 4 depicts a sub-atmospheric recirculating testing system for determining the moisture and carbon dioxide content of gas that has been passed through a TCC unit comprising sorbent of the invention. More specifically, the system comprises the following conductively engaged components: a) gas source comprising: 1) CO₂ source and associated first flow controller and valve; 2) humidified air source and associated first sub-atmospheric regulator, second flow controller, and valve; 3) first mixing valve downstream of the first and second flow controllers; and 4) second sub-atmospheric regulator downstream of the first mixing valve; b) downstream of the first and second sub-atmospheric regulators, a mixed-gas tank and associated relative humidity (RH) gauge and first pressure gauge; c) sub-atmospheric regulator downstream of the tank comprising, in the following sequence, a sub-atmospheric back regulator, flow-reducing valve, and vacuum pump; and d) sub-atmospheric testing loop, conductively engaged with the tank, comprising in the following sequence 1) sealed blower (pump); 2) splitter valve directing gas to a bypass line and a test-article line, said bypass line having a regulator, and said test-article line having a pressure gauge upstream of a TCC unit and a pressure gauge downstream of the TCC unit; 4) mixing valve downstream of the bypass line and test-article line and upstream of a gas-analysis loop. The system optionally further comprises in-line sensors, in particular conductively between the sealed blower and the splitter valve.

The largest component consists of a commercially available stainless steel compressor tank with a volume of approximately 24 L to simulate the xPLSS volume. A safety release valve, a relative humidity sensor, and a pressure gauge are connected to the tank utilizing KF-25 fittings. The recirculating loop includes KF-25 fittings, rigid straight sections, flexible bellows and right-angle couplers and tees, that ensure that all connections are vacuum tight while facilitating their removal and/or replacement for potential modifications. The KF-25 tubes have an inner diameter that is slightly less than 2.54 cm to enable a high flow without a significant pressure drop, thus minimizing the effort required by the blower to recirculate the gas. The KF-25 valves with a large inner diameter (conductance of 12 L/s) are chosen to minimize the pressure drop when the valve is opened. The 2.54-cm inner diameter tubing also results in a low Reynolds number indicating laminar flow, although this flow could be interrupted by the TCC unit.

The testing system is computer controlled. An Arduino-based microcontroller also allows data from a set of sensors to be collected from the outlet board and the regeneration or purge port. The sensor hardware includes Amphenol Telaire Dual Channel CO₂ Sensor Non-dispersive infrared Module, Winson ZE03-NH₃ Electrochemical gas sensor module with the I2C Interface, and a SHT75±1.8% digital humidity and temperature sensor. This set of sensors allowed real-time collection. The electrochemical gas sensor and T/RH sensors were placed inside PEEK plastic holders. The mechanized PEEK enclosures replaced the initial 3D printed enclosures whose porosity negatively affected CO₂ measurements. An Arduino-based controller was used to control the valves (swings) and measure the sensor inputs which were logged in the computer.

Testing of a sorbent (or respective container) of the invention is conducted according to the example below. In general, the gas sources (CO₂ and humidified air) are mixed within a mixed-gas tank so as to provide an air/water/CO₂ mixture approximating a target humidity and CO₂ content at a target pressure. The mixed gas is passed through a blower which forces the mixed gas through a splitter valve to a TCC (comprising sorbent(s) and/or container(s)) and a bypass linc. The two gas streams are then connected to another valve that directs the respective gases (treated (from TCC unit) and untreated (from bypass line)) to an in-line analysis injection loop and back to the mixed-gas tank.

More specifically, a Micronel blower (U100HL-024KA-4) that was able to maintain a steady flow through the apparatus at rates up to 8 ACFM was used. An in-line high-flow low-pressure drop flowmeter (HFM-200 LFE) was added after the pump to directly measure the flow during operation. During testing, an external anemometer was used to measure the gas velocity that was subsequently converted into a volume flow using the cross-sectional area. The two values agreed within approximately 5% for flows between 3 and 8 ACFM, demonstrating accurate performance of the in-line flow meter. The recirculation loop has two pathways controlled by three pneumatic valves. The bypass allows the assessment of any analyte loss by the recirculation subsystem that might impact subsequent assessments of the TCC performance. It also allows any unwanted contamination to be identified and eliminated before testing, facilitates the replacement of TCC unit without breaking the recirculation loop, and supports the regeneration subsystem (see below). On startup, bypassing the TCC unit also allows the target analytes to be loaded at the desired concentrations before the introduction of the TCC into the flow. The recirculation system is connected via KF-16 adapters to the KF-16 input and output ports of the TCC. Once connected, it can be purged and pre-pressurized to the loop pressure by the vacuum regeneration subsystem (see below) before the flow is switched from the bypass to the TCC pathway. Two piezo pressure gauges are connected directly across the TCC to monitor the pressure drop. The addition of the flowmeter (see above) proved to be important as changes in the flow path induced by switching from the TCC to the bypass pathway result in increased flow due to the elimination of the TCC hardware from the pathway. Thus, the blower is adjusted by the microcontroller to maintain constant flow when switching between these two paths.

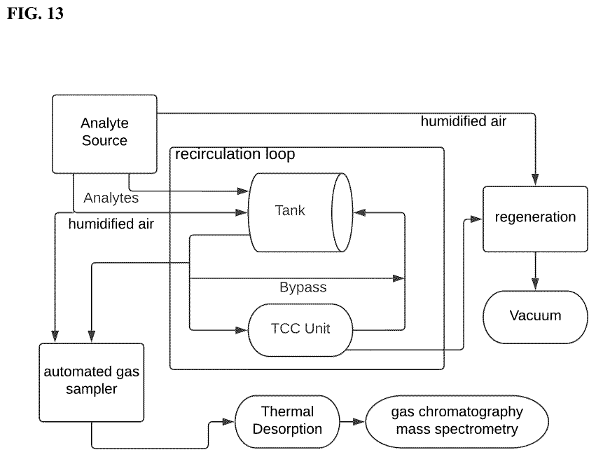

The gas source subsystem (FIG. 14), which is the source of gas and sorbates (analytes, compounds to be added to the gas and adsorbed onto the sorbent), is included as part of the testing system. In this exemplary embodiment, the source subsystem provides humidified air at the current pressure (varying from atmospheric to a desired sub-atmospheric pressure) and one or more of the analytes to be removed from the air. A pure air source is humidified by a water bubbler and then diluted to a desired RH (relative humidity). The pressure is regulated using a combination of a sub-atmospheric back pressure gas regulator connected to a vacuum pump combined with a standard regulator connected to the humidified air source. This setup maintains a stable pressure between 760 and 200 Torr depending on the test. During testing, the pressure regulation maintains the recirculation loop at 430 Torr with a precision of ±4 Torr for over 24 hours. The analytes were supplied by calibrated gas cylinders, except hexamethylcyclotrisiloxane, which required a more complex liquid-based vapor source. Mass flow controllers were used to mix the output of a calibrated gas cylinder with humidified air to generate a desired concentration of the analyte at the correct RH. This stream was then introduced into the recirculation loop to provide the final analyte concentration within the loop. During testing the OSU-6 sorbent, all 18 compounds could be generated at known concentrations near their 7-day SMAC limits.

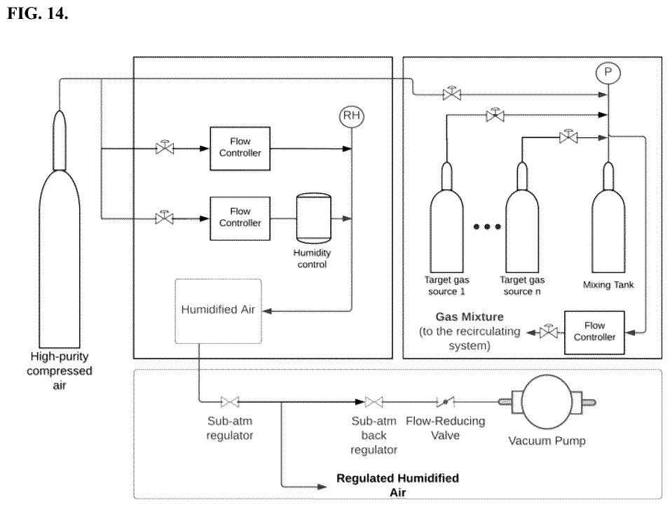

The sampling subsystem (FIG. 15), which conducts real-time measurement of analytes in the gas after it has passed through a sorbent bed, is included as part of the system. As gas mixtures will be utilized, separation is also critical for accurate measurements. This subsystem consists of two computer-controlled valves that divert some of the recirculation flow through a 10-mL loop. In the first version, the ports were connected across the blower while in the current version, the ports are located across the linear flow element used for in-line flow measurements. In both cases, the flow through the 10-mL loop was driven by the pressure drop across the ports. During this sample extraction, the valves isolate the 10-mL loop and use helium to flush this volume quantitively onto a thermal desorption tube. The volume of the injection loop is significantly larger than those of typical microliter sized loops used for direct sampling. The measurement is possible due to the direct transfer of the analytes to a thermal desorption tube where they are concentrated by adsorption. Once the sample gas is transferred, the loop is switched back into the flow and repressurized to the desired pressure using the regulated humidified air source from the Analyte Source subsystem. After each sampling, the analyte is lost from the recirculating system due to the removal of the injection loop volume (10 mL). However, this volume is small compared to the total volume of approximately 24 L. and can be compensated for computationally. As the loading of thermal desorption tubes can be performed quickly (within less than a minute at the large flow rate) and is independent of the analysis procedure, this setup permits in-situ and on demand evaluation of gas concentrations at known times that can be used to quantify the removal of contaminants by the TCC with time. After the loading of the thermal desorption tubes, thermal desorption (TD) with a Markes TD-100 instrument is performed to automatically desorb any adsorbed compounds under a helium flow into a focusing sorbent column held at −10° C. The system increases the sensitivity of the GC/MS apparatus by concentrating the contaminants from a fixed volume of gas (10 mL) inside the focusing column. Once the adsorbed contaminants are transferred, the rapid heating of the focusing column injects the adsorbed material into an Agilent GC/MS system for quantification. Importantly, the TD coupled with GC/MS provides separation of each compound in the gas stream facilitating the measurement of individual gas concentrations within the mixtures with high sensitivity and selectivity. Using this system, almost all NASA-specified compounds can be detected except carbon monoxide, methane, hydrogen and ammonia. These three gases are detected as needed using an optical (methane) or electrochemical (carbon monoxide, hydrogen, and ammonia) sensors placed in-line with the injection loop. During the measurement cycle, the microcontroller monitors the communication between the TD and GC/MS systems. For sampling, the TD sequencer initiates a start command at preset times. The microcontroller then ensures that the 10 mL loop is correctly switched and repressurized. The microcontroller also forces this subsystem to wait during a regeneration cycle.

The test system also includes a regeneration subsystem. When the test system is operated in the bypass mode, the TCC prototype is isolated between the two KF-25 valves. When isolated, additional solenoid valves can be used for vacuum regeneration and pressurization. A regulated 1-Torr vacuum is provided using a setup similar to that employed for regulating the pressure in the recirculation loop. A sub-atmospheric back pressure gas regulator is connected to a vacuum pump combined with another standard regulator connected to a contamination-free air source. This setup maintains a stable pressure between the regulators of 1.00 Torr. The precision of the vacuum gauge is +10 mTorr at this pressure. Once the TCC unit is isolated, this valve opens for 2 minutes, reducing the pressure on both sides of the TCC unit to 1 Torr within a few seconds. After 2 minutes, a pressurization valve opens to quickly repressurize the unit to the loop pressure using the recirculation loop regulated pressure source described above. After a few seconds, the TCC loop is reconnected to the recirculation loop. As testing continues with the prototype TCC unit, the vacuum system may require that an additional amount of ballast be added to handle sudden changes in pressure.

Preliminary tests showed the test system works efficiently with a TCC stand-in in the form of an exemplary glass tube (alternate embodiment of a container) loaded with a 1.5 cm long column of OSU-6 sorbent. Preliminary regeneration tests using the TCC stand-in were conducted using once and three loading-regeneration cycles for furan and toluene. For each cycle, the analyte was loaded at a flow rate of 100 ml/min up to 20% of its measured breakthrough capacity (20 s at 1 ppm for furan and 26 s at 100 ppm for toluene) and then exposed to the 1-Torr vacuum for 2 minutes. The analyte concentration in the column after one and three loading-regeneration cycles was determined by TD followed by GC/MS. After one regeneration cycle, 99% and 71% of the initial loadings for furan and toluene, respectively, were removed from the sorbent. The remaining concentrations of these analytes after three regeneration cycles corresponded to 0% and 43% of the initial loadings for furan and toluene, respectively. The error for these measurements is approximately 7%. Additional loading-regeneration cycles show that after three regeneration cycles, the final value may be indicative of the constant fraction of the material remaining on the sorbent surface.

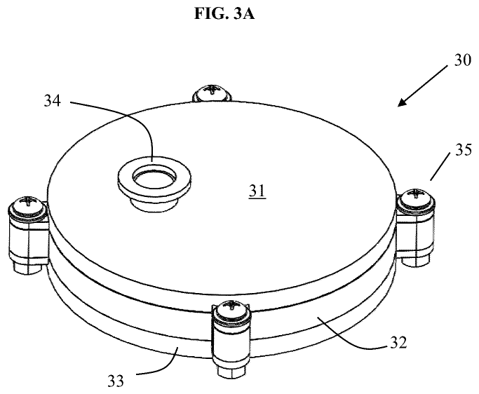

FIG. 5 depicts a generalized schematic of an alternate embodiment of the sub-atmospheric recirculating testing system comprising a source of zero grade air (50), source of target gas mixture (51), flow controllers (52), water source (53, through which the air is flowed), air filter (54), sorbent-containing container (55) and conduits leading to three different testing systems. The system allows for three modes of dosing setups that facilitate the dosing of sorbent columns with precise concentration of the target analytes. The dosing setups include (1) an automated setup for the in-line breakthrough assessment and direct (injection) sample analysis based on automated sample transfer to the thermal desorber (Mode 1); (2) a sorbent column breakthrough (56) and capacity evaluations setup based on a traditional in-line dosing approach where samples were manually transferred to the thermal desorber (Mode 2); and (3) in situ concentration measurements using an electrochemical, chemiresistive, or optical gas sensor for select analytes that may be difficult to quantify by TD-GC/MS (Mode 3).

Mode 2 testing was used to conduct breakthrough studies on eleven analytes, including acetaldehyde, acetic acid, acetone, acrolein, 1-butanol, ethanol, formaldehyde, furan, methanol, methyl ethyl ketone, and toluene. Mode 3 testing was used to conduct breakthrough testing on ammonia, carbon monoxide, hydrogen, methanol, and methyl mercaptan. Dosing concentrations were established for executing the uptake and breakthrough studies. All dosing runs were conducted at a flow rate of 100 mL/min, a temperature of approximately 24° C., and two RH levels (40% and 85%). The corresponding column residence time was 0.08 seconds. Analyte concentrations were selected to match their 7-day SMAC limits. For some target compounds with extremely low (methyl mercaptan, acrolein, furan, and formaldehyde) or high (ethanol, hydrogen, methane) exposure limits, dosing concentrations were adjusted to ensure their accurate quantification by TD-GC/MS. OSU-6, Carbograph V, and Ammonasorb II sorbents were evaluated. All uptake and breakthrough curves were fitted using an in-house developed software code to determine the breakthrough times, breakthrough volumes, and sorption capacities of each analyte.

The vacuum regeneration capabilities of OSU-6 sorbent under relatively mild vacuum conditions (1 Torr background pressure) were evaluated using a vacuum regeneration setup consisting of a sub-atmospheric back pressure gas regulator connected to a vacuum pump with a minimum pressure of 15 mTorr. This regulator maintained a constant pressure upstream in a manifold connected to a sorbent column, vacuum pressure gauge, and single-stage sub-atmospheric pressure gas regulator for minor pressure adjustments at the higher end. The fabricated setup maintained a stable pressure below 1 atm in controllable way and thus mimicked an array of potential TCC operating conditions. Ten different contaminants were loaded into OSU-6 sorbent tubes at a specified capacity determined from the corresponding breakthrough data and then pumped at a pressure of 1 Torr for 2 minutes. One and three loading-regeneration cycles were performed for each analyte, and the sorbate amounts before and after regeneration were measured by TD GC/MS to estimate the regeneration efficiency and change in sorbent capacity. Experiments showed that three cycles were sufficient to characterize the long-term sorbent performance.

The testing system described herein was used to compare performance of the sorbents Ammonasorb II, Carbograph V, and OSU-6. The following table details the breakthrough times, breakthrough volumes, and sorption capacities of the compounds evaluated by TD-GC/MS (Mode 2).

| | | Relative | | | Sorption |
|---|---|---|---|---|---|
| | | humidity | Breakthrough | Breakthrough | capacity |
| Analyte | Sorbent | (%) | time (s) | volume (cm³) | (mg/g) |
| Acetone | OSU-6 | 85 | 166 | 278 | 0.31 |
| (22 ppm) | | 40 | 961 | 1607 | 2.0 |
| | Carbograph | 40 | 258 | 432 | 0.30 |
| | V | | | | |
| | Ammonasorb | 40 | 1014 | 1696 | 0.46 |
| | II | | | | |
| Methanol | OSU-6 | 85 | 184 | 306 | 0.72 |
| (70 ppm) | | 40 | 260 | 433 | 1.0 |
| | Carbograph | 40 | Negligible | | Below LOQ |
| | V | | | | |
| | Ammonasorb | 40 | 819 | 1361 | 2.6 |
| | II | | | | |
| Furan | OSU-6 | 85 | 5 | 8 | 0.00048 |
| (1 ppm) | | 40 | 17 | 28 | 0.002 |
| | Carbograph | 40 | 1085 | 1818 | 0.098 |
| | V | | | | |
| | Ammonasorb | 40 | 1105 | 1818 | 0.098 |
| | II | | | | |
| Toluene | OSU-6 | 85 | 10 | 17 | 0.18 |
| (101.1 ppm) | | 40 | 354 | 590 | 4.8 |
| | Carbograph | 40 | 2619 | 4364 | 19.7 |
| | V | | | | |
| | Ammonasorb | 40 | 6733 | 11221 | 33.8 |
| | II | | | | |
| Ethanol | OSU-6 | 85 | 352 | 586 | 3.0 |
| (100 ppm) | | 40 | 989 | 1648 | 7.2 |
| | Carbograph | 40 | 118 | 197 | 0.87 |
| | V | | | | |
| | Ammonasorb | 40 | 2347 | 3922 | 11.6 |
| | II | | | | |
| Methyl ethyl | OSU-6 | 85 | 338 | 561 | 0.34 |
| ketone | | 40 | 4006 | 6650 | 4.0 |
| (10 ppm) | Carbograph | 40 | 2393 | 3972 | 5.8 |
| | V | | | | |
| | Ammonasorb | 40 | Did not breakthrough after 8 hours | | |
| | II | | | | |
| Acrolein | OSU-6 | 85 | ~60 | ~100 | 0.0007 |
| (0.45 ppm) | | 40 | 517 | 862 | 0.064 |
| | Carbograph | 40 | 965 | 1609 | 0.031 |
| | V | | | | |
| | Ammonasorb | 40 | 3000 | 5224 | 0.043 |
| | II | | | | |
| 1-Butanol | OSU-6 | 85 | 157 | 263 | 0.23 |
| (14.3 ppm) | | 40 | 6144 | 10281 | 9.0 |
| | Carbograph | 40 | 3903 | 6532 | 3.3 |
| | V | | | | |
| | Ammonasorb | 40 | Did not breakthrough after 6 hours | | |
| | II | | | | |
| Formaldehyde | OSU-6 | 85 | 2366 | 3943 | 0.019 |
| (0.2 ppm) | | 40 | 513 | 855 | 0.0042 |
| | Carbograph | 40 | 67 | 112 | 0.00042 |
| | V | | | | |
| | Ammonasorb | 40 | 107 | 178 | 0.0027 |
| | II | | | | |
| Acetaldehyde | OSU-6 | 85 | 12 | 19 | 0.0025 |
| (2 ppm) | | 40 | 77 | 129 | 0.040 |
| | Carbograph | 40 | 11 | 19 | 0.00064 |
| | V | | | | |
| | Ammonasorb | 40 | 242 | 403 | 0.028 |
| | II | | | | |
| Acetic acid | OSU-6 | 85 | 11912 | 19972 | 3.0 |
| (3 ppm) | | 40 | 6570 | 11016 | 2.7 |
| | Carbograph | 40 | 6380 | 10697 | 1.1 |
| | V | | | | |
| | Ammonasorb | 40 | Did not breakthrough after 4 hours of dosing | | |
| | II | | | | |

The following table details the breakthrough times, breakthrough volumes, and sorption capacities of the compounds evaluated by sensor-based analysis (Mode 3).

| | | Relative | 50% | Sorption |
|---|---|---|---|---|
| | | humidity | Breakthrough | capacity |
| Analyte | Sorbent | (%) | time (s) | (mg/g) |
| Ammonia | OSU-6 | 40 | 481 | 1.4 |
| (30 ppm) | Carbograph V | 40 | 16 | 0.08 |
| | Ammonasorb II | 40 | 1030 | 16 |
| Methane | OSU-6 | 40 | 2 | 0.2* |
| (5000 ppm) | Carbograph V | 40 | 2 | 0.1* |
| | Ammonasorb II | 40 | 0 | 0* |
| Methyl mercaptan | OSU-6 | 85 | 12 | Negligible |
| (0.5 ppm) | | 40 | 37 | 0.00044 |
| | Carbograph V | 40 | 63 | Negligible |
| | Ammonasorb II | 40 | Did not | >0.95 |
| | | | breakthrough | |
| | | | after 20 hours | |

*Approximated from 50% breakthrough times

The above data indicate that the three known sorbents exhibit different uptake capacities and breakthrough times for specific contaminants (analytes). Moreover, the moisture content in the air could impact the performance of the sorbent in terms of uptake capacity and/or breakthrough time. Importantly, the sorption capacities of OSU-6 were comparable to those of the non-regenerable Ammonasorb II sorbent currently used in the xPLSS and considerably exceeded the capacities of the activated carbon-based Carbograph 5 sorbent. Even so, OSU-6 exhibited loss in uptake capacity after only three vacuum regeneration cycles, as demonstrated by the data in the following table.

| | | | Analyte removal after | Capacity loss after |
|---|---|---|---|---|
| | Capacity | Mass | one regeneration cycle | three regeneration |
| Analyte | load (%) | (μg) | (%) | cycles (%) |
| Acetaldehyde | 20 | 0.40 | 67 | 24 |
| Acetic acid | 20 | 27 | 21 | 20 |
| Acetone | 20 | 26 | 12 | 28 |
| Acrolein | 20 | 0.64 | 32 | No loss |
| 1-Butanol | 20 | 110 | 13 | 19 |
| Formaldehyde | 20 | 0.042 | 41 | 46 |
| Furan | 40 | 0.040 | 99 | No loss |
| Methyl ethyl | 20 | 40 | 16 | 11 |
| ketone | | | | |
| Methyl mercaptan | 77 | 0.017 | 79 | No loss |
| Toluene | 7 | 16.8 | 71 | 43 |

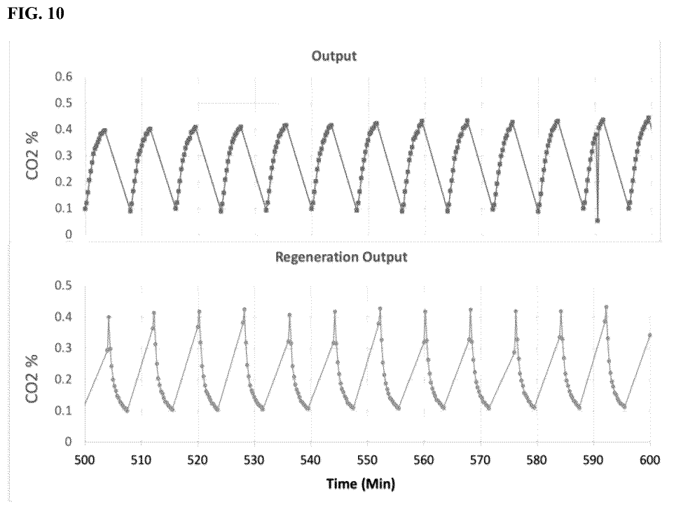

Further evidence of the poor performance of known sorbents was obtained. FIG. 11 depicts a graph of the output of CO₂ during corresponding sequential cycles of air treatment and vacuum regeneration during a 250 min test period for the known sorbent SYLOBEAD MS 544C (100 mL bed volume in each of two beds), a commercial off the shelf sorbent for carbon dioxide and humidity control (previously as evaluated by NASA ICES-2016-48). This test was conducted for over 22 hours, during which 170 full swings (4 minute per swing) were conducted to evaluate the breakthrough of 1% (10,000 ppm) CO₂ conducted at a humidity of 40% RH and total flow of 2 L/min. In this swing bed setup, the two beds alternated between exposure to CO₂ and humidified air (40% RH) for 4 minutes respectively. When one bed was exposed to CO₂ the other was being regenerated by exposure to humidified air. Thus, a cyclic test was setup. Breakthrough occurred when the CO₂ measured by the sensor at the outlet of the bed was at or above 1% when the bed was in the dosing cycling, i.e. being exposed to CO₂. Likewise, water breakthrough occurred when humidity level reached at or above 40% on the regeneration bed when the bed was being exposed to humidified air at 40% RH. For SYLOBEAD MS C 544 CO₂ breakthrough was observed in the uptake bed after 20 hours while the moisture breakthrough occurred after 17 hours. It is important to note that the SYLOBEAD SORBENT does not regenerate completely and becomes less and less efficient with each vacuum regeneration cycle.

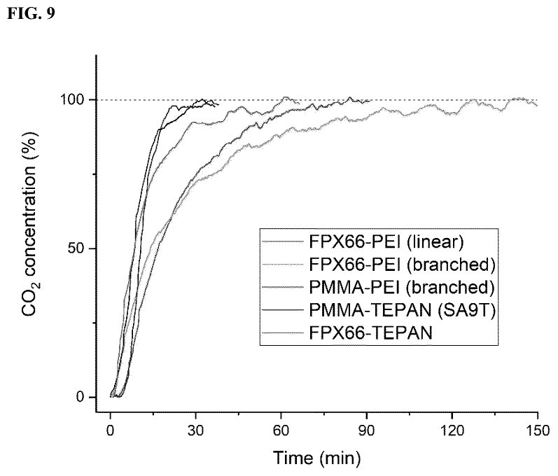

On the other hand, the sorbents of the invention are essentially completely or almost completely vacuum regenerable. In contrast to SYLOBEAD, FPX66-PEI shows removal and good regeneration. FIG. 10 depicts graphs of the output of CO₂ during corresponding sequential cycles of air treatment (uptake, adsorption, FIG. 10, upper) and vacuum regeneration (desorption, FIG. 10, lower) during a 10-h test period for the FPX66-PEI sorbent (100 mL bed volume in each of two beds; 68.9% loading of PEI onto the substrate). For this test a flow of 2.0 L/min in air was used. The CO₂ concentration was 1% (10000 ppm) and RH was set at 40%. The flow started shortly after 300 minutes. The initial increase in baseline CO₂ most likely occurred due to the saturation of non-reversible sites within the sorbent. After saturating these sites, the sorbent was still able to remove 50% of the CO₂ from the stream and regenerate for the next swing. The ultimate removal was limited by the bed volume. Although not depicted in the drawings, this sorbent was successfully operated for over 17 hours during which time the CO₂ concentration was kept significantly below 1%.

Accordingly, the sorbents of the invention provide unexpectedly improved performance as compared to known sorbents.

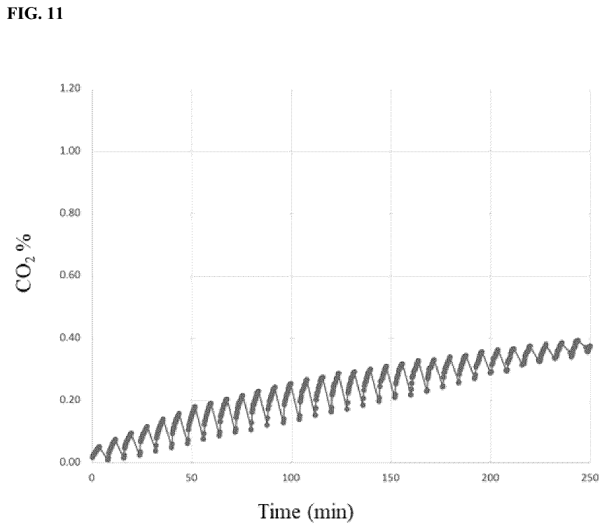

FIG. 12 depicts a top-plan view of a pressure swing bed recycling unit as an exemplary TCC. A simple swing bed was developed starting with an off the shelf setup (Altec Air 51430 mini desiccant air dryer), this was completely retrofitted with new valves and an Arduino based microcontroller. The cylinders are 7″ long×1″ in diameter and can hold about 100 cm³ of the sorbent media. The initial design had air flow through one cylinder and out, with some split flow to flush the other tube. The shuttle valve was replaced by a 4-way valve, which allowed the system to be purged by an external air source or even by using vacuum. In addition, the cycle times could be easily changed and cylinder heating was possible. The unit was redesigned to allow regeneration using an auxiliary gas flow or vacuum for regeneration. Thus, the system included two 4-way valves. Cylinders were selected for the beds in order to eliminate the dead volume, ensure a uniform flow, and allow easy modeling.

Each tower contains sorbent so that sorbent in one tower, e.g. left tower, is being used to dry humid air, and sorbent in the other tower, e.g. right tower, is being vacuum regenerated. In this particular mode of operation, compressed air enters the 4-way valve and then is forced through the first bed to dry the air, which then passes through a 3-way valve and exits the TCC. At substantially the same time, water-containing sorbent in the second bed is being regenerated by exposure to vacuum to remove moisture adsorbed onto the bed from a prior use/treatment cycle. This first half of a swing cycle is conducted until the amount of moisture or other sorbate in the treated gas exceeds a target limit. At that time, the valves of the unit are switched, whereby the first bed of sorbent is regenerated under vacuum while the second bed is used to treat air, such as in a spacecraft, spacesuit, or other enclosed land craft or watercraft.

Reported 7-day Spacecraft Maximum Allowable Concentrations (SMAC) limits for 18 compounds (analytes) specified by NASA for the removal by the TCC are as follows. The Source Rate is the projected generation with time of each compound within the xPLSS system. Data with the quoted significant figures are provided by NASA.

| | Total Source Rate | 7-Day SMAC Limit |
|---|---|---|
| Analyte | (mg/day) | (ppm) |
| Acetaldehyde | 0.663 | 2 |
| Acetic acid | 0.227 | 3.01 |
| Acetone | 0.193 | 22 |
| Acrolein | 0.006 | 0.015 |
| Ammonia | 80 | 3 |
| 1-Butanol | 0.50 | 25 |
| Carbon Monoxide | 18 | 55 |
| Ethanol | 4.51 | 1000 |
| Formaldehyde | 0.42 | 0.1 |
| Furan | 0.3 | 0.025 |
| Hexamethylcyclotrisiloxane | 0.00396 | 10 |
| Hydrogen | 42.0 | 4100 |
| Methane | 329. | 5300 |
| Methanol | 1.02 | 70 |
| Methyl-Ethyl Ketone | 0.907 | 10 |
| Methyl mercaptan | N/A | 0.2 |
| Toluene | 1.35 | 4 |
| Trimethyl Silanol | 0.2 | 1 |

The sorbents of the invention effectively remove those compounds from the air to acceptable levels.

The key substrates included in the sorbents of the invention comprise mesoporous silica, PMMA, and S-DVB, each as described. The sorbent comprises the substrate derivatized with adsorption modifier, which improves the performance of the sorbent in terms of capture (uptake, adsorption) and vacuum-release (desorption) of compounds. The adsorption modifier is either covalently or noncovalently bound to the substrate. The weight percentage of loading of the adsorption modifier onto the substrate can be modified to provide particularly improved performance. The preferred ranges for the loading percentage may be specific to particular adsorption modifier and substrate combinations.

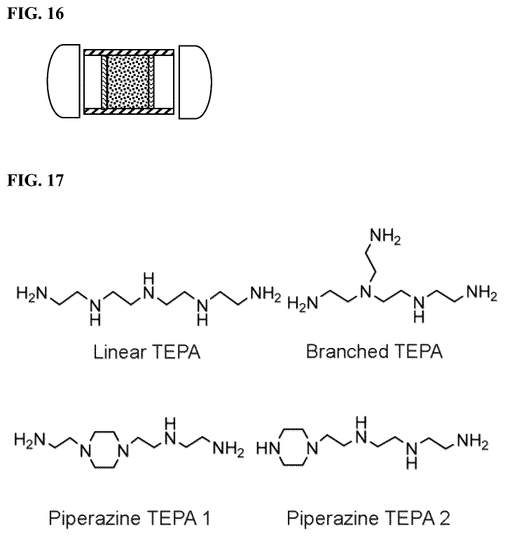

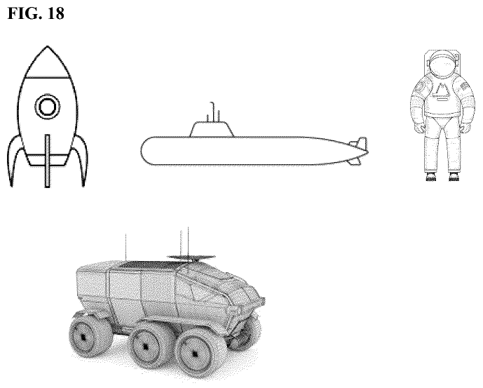

FIG. 17 depicts the chemical structure of some of the TEPANs that can be used to derivatize the sorbent. In some embodiments, the preferred TEPAN is linear TEPAN.

The mesoporous silica can be non-functionalized or functionalized. For example, the mesoporous silica may be functionalized by treating it with a trialkoxyalkylsilane (R¹Si(OR²)₃), wherein:
R¹ is selected from the group consisting of aromatic group, alkyl group, oxygen-containing alkyl groups, sulfur-containing alkyl groups, nitrogen-containing alkyl groups, phenyl, biphenyl, (C1-C8)-alkyl, methyl, ethyl, propyl, butyl, pentyl, hexyl, heptyl, octyl, methoxytriethyleneoxypropyl, alkoxyalkyleneoxyalkyl, haloalkyl, halo-(C1-C8)-alkyl, aminoalkyl, alkoxyalkyl, polyaromatic, toluyl, fluoroalkyls, fluroaromatics, and their combinations; and
R² is selected from the group consisting of alkyl, C1-C12-alkyl, with methyl, ethyl, and propyl being preferred,
thereby forming a silane-functionalized mesoporous silica comprising plural silane groups R¹Si-covalently bound to oxygen molecules of the mesoporous silica.

Exemplary trialkoxy silanes (or trialkoxy alkylsilanes) include:

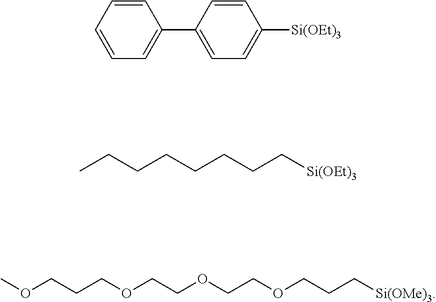

Such a silane-functionalized mesoporous silica generally has the following chemical formula: silica-O—Si(R¹)(OR²)ₙ—Oₘ—; wherein n is 0, 1 or 2, and m is 2, 1, or 0, respectively. Functionalization of the mesoporous silica converts the silicon oxide/hydroxide surface within the pores of the mesoporous silica into the desired derivatives by formation of an organosilsequioxane polymer grafted to the surface of the silica.

Its high surface area allows the sorbent to uptake relatively large amounts of VOC and SVOC. The sorbent exhibits exceptional adsorption capacity, rate of capture and a high propensity to stabilize even compounds such as acetaldehyde and methylene chloride. After adsorption of VOC or SVOC, the sorbent can be introduced directly into the sample chamber of an analytical instrument, e.g. gas chromatograph and/or mass spectrometer, if desired, for rapid quantitation and/or identification of the adsorbed VOC or SVOC. In some embodiments, the sorbent retains an adsorbed VOC or SVOC even after exposure of a VOC-containing or SVOC-containing sorbent to a temperature of up to about 40° C., up to about 45° C., or up to about 50° C. for a period of up to about a week (which was observed for compounds with relatively high maximum desorption temperatures such as 1,2,4-trimethylbenzene and naphthalene).

Functionalized mesoporous silica can be made according to the following generalized procedure. Non-functionalized mesoporous silica is rendered anhydrous by removal of substantially all moisture, such as by azeotropic distillation and/or desiccation with or without heat and at atmospheric or reduced pressure. For example, the mesoporous silica is refluxed in dry organic liquid under dry atmosphere to remove moisture. The organic liquid is removed from the mesoporous silica by drying under heat at reduced pressure. The dried mesoporous silica is suspended in organic liquid and treated with triethanolamine (TEA) at room temperature to form TEA-mesoporous silica (TEA-MS). The TEA-MS solids are then separated from the supernatant. The recovered TEA-MS solids are washed with dry organic liquid, and optionally vacuum-dried. The TEA-MS is suspended in organic liquid and treated with functionalizing agent while heating and mixing. The functionalized mesoporous silica (MS) is separated from the supernatant and washed with organic liquid. Functionalization was performed according to Example 4.

Functionalized sorbent may exhibit different performance properties than non-functionalized sorbent. Example 9 describes the results of a study comparing the uptake capacities and uptake rates for four different sorbents. The data indicate that the uptake capacity of the sorbent decreases with surface functionalization which is mainly due to reduced surface area; however, an advantageous increase in the rate of uptake for specific target compounds was observed for the functionalized mesoporous silica.

The sorbent can comprise (or consist essentially of or consist of) non-functionalized sorbent, functionalized sorbent, or a combination (mixture) of non-functionalized sorbent and functionalized sorbent. In some embodiments, non-functionalized sorbent comprises the majority of the mixture. In some embodiments, functionalized sorbent comprises the majority of the mixture. In some embodiments, non-functionalized sorbent and functionalized sorbent are present at about the same amount.

The weight ratio of non-functionalized sorbent to functionalized sorbent can range from about 1:100 to about 100:1 with all integer and fractional values therein being contemplated. In some embodiments, the ratio ranges from about 80:20 to about 20:80, about 70:30 to about 30:70, about 60:40 to about 40:60, about 80:20 to about 40:60, about 80:20, about 95:5, about 90:10, about 70:30, about 60:40, about 50:50, about 40:60, about 30:70, about 20:80, about 90:10, or about 95:5.

Exemplary suitable ranges for the weight percentage of the different types in the mixture can be as follows, wherein the sum total of the weight percentages is 100%.

| Non-functionalized | 1^{st} Functionalized | 2^{nd} Functionalized |
|---|---|---|
| sorbent (% wt) | sorbent (% wt) | sorbent (% wt) |
| 100 | 0 | 0 |
| about 80 or less | up to about 10 | 10 |
| about 75 or less | up to about 15 | up to about 10 |
| about 50 or less | up to about 30 | up to about 20 |
| about 5 to less than | up to about 95 | 0 |
| 100 | | |
| up to about 95 | about 5 to less | 0 |
| | than 100 | |
| ^{a} about 5 to less than | less than about 95 | less than about 95 |
| 100 | | |
| ^{b} less than about 95 | about 5 to less | less than about 95 |
| | than about 100 | |

^{a} wherein the total of 1^{st} and 2^{nd} functionalized sorbent is up to 95% wt.
^{b} wherein the total of non-functionalized and 1^{st} functionalized sorbent is up to 95% wt.

The sorbent can be provided in forms such as compressed, non-compressed, pellets, tablets, discs, beads, loose powder, bound powder, powder enclosed in porous container, powder in sachet or bag.

The sorbent can be placed in the cavity in any form desired, but if it is included as a powder, then the ports of the cap will comprise generally comprise a porous, permeable or perforated cover to help retain the sorbent within the cavity (ies). The sorbent can also be placed as a powder in a sorbent holder, e.g. sachet or porous bag, in which case the covering of the ports is optional. When fully assembled and before deployment for use, the cavity (ies) are sealed and isolated from the outer environment, thereby avoiding contamination of the sorbent. During use, the cover is moved/slid/rotated, and the sorbent is exposed to the atmosphere. After use, the cover can be used to reseal the badge for storage. As needed, one or more of the portions (sections) of sorbent are then removed from the dosimeter and subject to analytical testing for quantitation of captured VOC and SVOC.

Sorbent can be employed as loose powder, sorbent containing cartridges, or other such forms (tablets, pellets, sachets). Suitable forms, such as a container, e.g. cartridge or tube, containing sorbent can be made by using a porous or gas-permeable material to retain the sorbent. The pores of the material would have to be smaller than the average particle size of the sorbent but large enough to permit diffusion of gas from the environment and into the sorbent.

A particularly useful material is porous PTFE (polytetrafluoroethylene; e.g. Teflon®) tubes for holding non-functionalized OSU-6 sorbent inside the housing of the injection molded dosimeters. Porous PTFE tubes and sheets including porous PTFE tube from Markel Corporation can be used. The ends of the PTFE tube can be sealed.

In some embodiments, a device of the invention includes ports (vents) that are fully or partially opened or are adjustable as to extent of opening.

The sorbents were evaluated in terms of the adsorption (uptake) capacity, adsorption (uptake) rate, extend to desorption, and extent of regenerability under vacuum (pressure swing cycle regeneration). The best performing sorbents were those that met or exceeded the spacesuit performance specifications for adsorption and regeneration. The following unexpected improvements were observed for the sorbents of the invention:
As compared to branched PEI adsorption modifier, the linear PEI adsorption modifier exhibited improved extent of desorption together with improved vacuum regenerability, no off-gassing of ammonia, no decomposition of contaminants (sorbates), no creation of byproducts, and the feasibility of in situ regeneration of the sorbent bed in the TCC.
As compared to branched TEPAN adsorption modifier, the linear TEPAN adsorption modifier at a loading ratio of about 30-88% exhibited improved extent of desorption together with improved vacuum regenerability. FPX66-TEPAN exhibited CO₂ binding capacity of 1.6 g/100 g of sorbent, and the Xplo-SA9T exhibited CO₂ binding capacity of 2.3 g/100 g of sorbent at a CO₂ concentration of 500 ppm.
As compared to known sorbents, the preferred sorbents of the invention exhibited both high adsorption capacity and at least 99% vacuum regenerability.
As compared to known sorbents, the preferred sorbents exhibited negligible levels of off-gassing of volatiles.

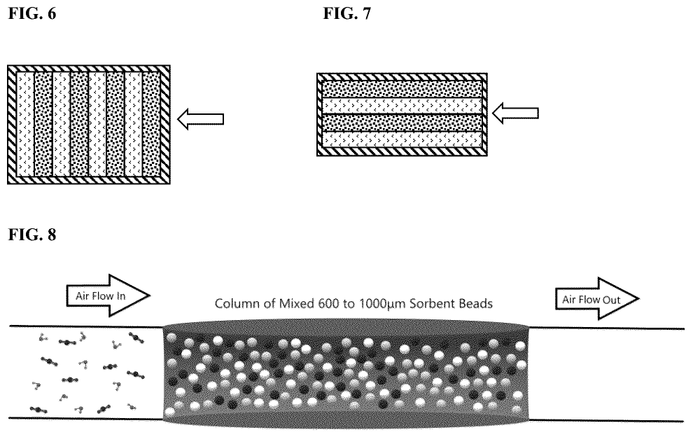

Among the studied sorbents, the excellent CO₂ adsorption performance was demonstrated by PEI-functionalized FPX66 (both the linear and branched ones), PEI-functionalized OSU-6, PEI-functionalized PMMA, and TEPAN-functionalized FPX66 at a relative humidity of 39%. Their CO₂ uptake capacities are listed in in the following table, while the corresponding CO₂ breakthrough curves are displayed in FIG. 9A (here, a commercial SA9T analog, Xplo-SA9T is provided as a reference).

| | Loading | Particle size | CO₂ adsorption capacity | |
|---|---|---|---|---|
| Sorbent | (%) | (μm) | g/100 g sorbent | mmol/g sorbent |
| FPX66-PEI (linear) | 40 | 600-750 | 2.6 | 0.60 |
| | 52 | | 2.3 | 0.52 |
| | 60 | | 2.3 | 0.52 |
| FPX66-PEI (branched) | 61 | 600-750 | 3.3 | 0.76 |
| FPX66-TEPAN | 41 | 600-750 | 1.6 | 0.37 |
| OSU6-PEI | 50 | 250-420 | 3.1* | 0.70 |
| | 75 | | 1.4 | 0.32 |
| PMMA-PEI | 43 | Approx. 300 | 1.6 | 0.37 |
| Xplo-SA9T | 75 | 600-1000 | 2.3^{#} | 0.53 |

*Measured at a relative humidity of 54%.
^{#}Measured at a relative humidity of 52%.

The CO₂ adsorption capacities of these sorbents exposed to only 500 ppm of CO₂ at RH=39% ranged from 1.4-3.3 g CO₂/100 g sorbent. The PEI-functionalized FPX66, TEPAN-functionalized FPX66, and Xplo-SA9T sorbents also satisfy the NASA bead size requirements of 600-1000 μm.

A major technical breakthrough was the demonstration of vacuum regeneration for two of the developed sorbent materials under NASA's required conditions of desorption pressure of 140 Pa (approximately 1 Torr) conducted for a 2-minute half-cycle. This included linear polyethylenimine (L-PEI) based sorbents developed on a resin support (Dupont Amberlite FPX66) and a SA9T type material Xplo-SA9T-polymethylmethacrylate (PMMA) with acrylonitrile-modified tetraethylenepentamine (TEPAN). In contrast to thermal regeneration, the vacuum regeneration effect for FPX66 resin functionalized with branched PEI (FPX66-PEI) was relatively weak as a 90% decrease in capacity was observed after pumping CO₂-saturated sorbent (100% loading) for 2 min at 1 Torr. However, the capacity of the same branched FPX66-PEI sorbent loaded with 20% CO₂ and vacuum regenerated under the same conditions decreased from 3.3 to 2.7 g/100 sorbent (approximately 18% decrease in capacity). In contrast no capacity decrease was observed for the FPX66 sorbent functionalized with linear PEI and exposed to 20% CO₂ after one regeneration cycle. Xplo-SA9T exhibited similar characteristics to FPX66 sorbent functionalized with linear PEI and showed a negligible decrease in capacity when exposed to 20% CO₂ after one regeneration cycle. It must be noted that the overall measured capacity for FPX66 sorbent functionalized with linear PEI is about relatively higher than that of literature SA9T sorbent as shown in the table above.

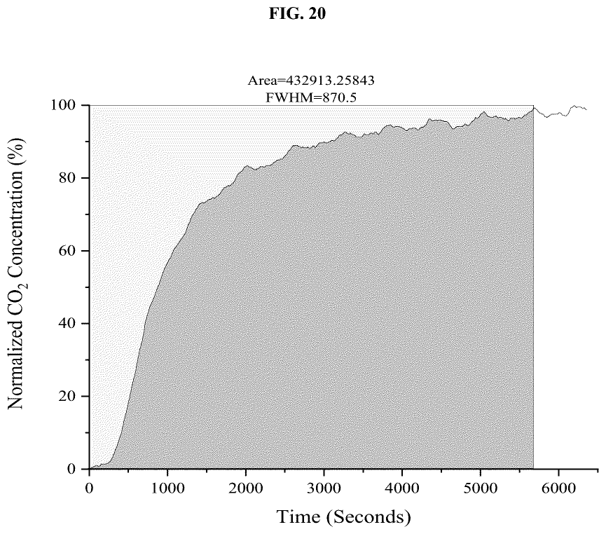

The Xplo-SA9T resin of the invention provided much improved CO₂ absorption (breakthrough capacity) and regeneration as compared to SA9T resin. FIG. 20 depicts a graph of the CO₂ breakthrough capacity after regeneration of Xplo-SA9T with positive nitrogen flow at 60° C. for 2 hours. The data were collected with a tube conditioner set to regenerate at 60° C. for 2 hours. Xplo-SA9T was loaded into glass TD tubes and ran until breakthrough, at which point the tubes were regenerated with a tube conditioner. For the experiment, a CO₂ concentration of 500 ppm and 52% RH was used. The initial capacity for Xplo-SA9T was noted as 0.529±0.019 mmol/g, and once regenerated, the capacity fell by ˜5% to 0.505±0.021 mmol/g. Multiple regeneration cycles from the same triplicate samples were performed with the tube conditioner, and after five regeneration cycles, the material remained useful with ˜88% of its initial capacity remaining (0.468±0.010 mmol/g).

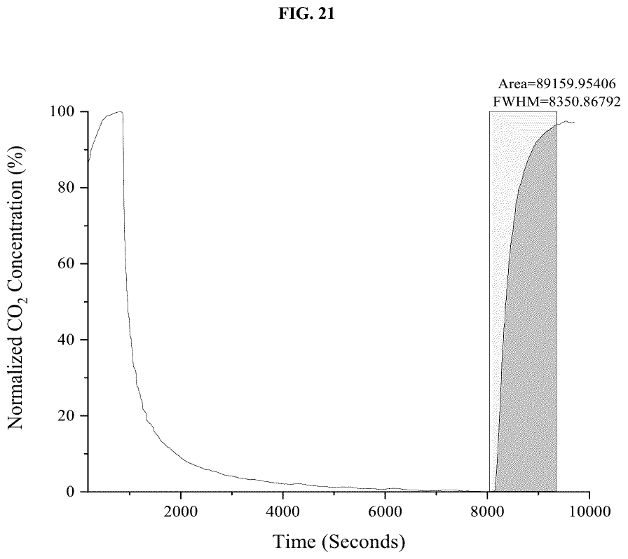

FIG. 21 depicts a graph of the regeneration of Xplo-SA9T on the CO₂ breakthrough rig by positive pressure. Regeneration on the breakthrough rig utilizing positive gas flow (100 mL/min zero-grade air) was proven possible at 25.1° C. within an average of 2.03 hours. First, the sorbent was exposed to CO₂ until full breakthrough, then only the 100 mL/min flow of zero-grade air passed over the sample until a minimum plateau was reached. Second, a subsequent 0-99% capacity was collected and compared to the initial triplicate capacity for the same lot of sorbent at the same 52% RH and 2,800 ppm CO₂ concentration. The initial capacity for the Xplo-SA9T sorbent was measured at 1.037±0.005 mmol/g compared to rig-regenerated material at 0.939±0.058 mmol/g. This reveals a ˜91% regeneration at ambient temperature with a flow rate of 100 mL/min of zero-grade air.

For another sample of Xplo-SA9T, sorbent was tested for functionality by measuring 0-99% total CO₂ breakthrough capacity in a dosing rig. Initially, the sorbent was tested using a similar literature procedure as Monje and co-authors, utilizing 2800 ppm CO₂, 52% RH, and a 60-minute exposure time, with a reduced flow rate of 100 mL/min to accommodate the smaller adsorbent bed size of 4 mm×14 mm. The literature values for the 60-minute exposure result in a calculated CO₂ capacity of 0.422±0.001 mmol/g for SA9T, whereas Xplo-SA9T revealed a CO₂ capacity of 1.037±0.005 mmol/g. Further tests compared variations in inlet CO₂ ranging from 500-10,500 ppm CO₂ with breakthrough capacities of 0.53±0.02 mmol/g and 1.97±0.04 mmol/g (500 and 10,500 ppm, respectively).

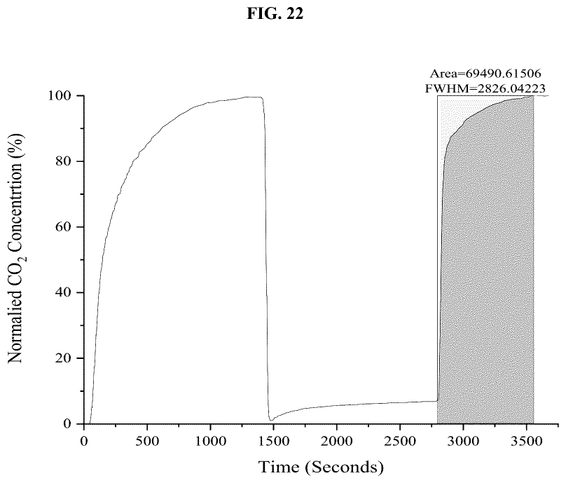

FIG. 22 depicts a graph of the vacuum regeneration of Xplo-SA9T post-full breakthrough. Vacuum regeneration of sorbent on the breakthrough rig first required the alteration of the rig itself. The stabilization humid air flow was disabled to ensure any regeneration occurred only by vacuum. The samples were exposed to a concentration representative of a high metabolic rate [52% RH and 100 ml/min of 10,500 ppm (7.98 mmHg) CO₂] for each ˜95 mg sorbent quantity. Once a full breakthrough occurred (outlet concentration matches inlet concentration), the tubes were capped then transferred to the 1.00 torr vacuum rig and evacuated for a pre-determined time. After evacuation, they were returned to the breakthrough rig and immediately reexposed to identical test conditions. The initial adsorption capacities were calculated as were their corresponding regenerated capacities.

Water uptake capacities for Xplo-SA9T were consistent, when compared to SA9T, (69 ±1.0 g·kg-1), for a humid stream coupled with CO₂. They were measured after dosing dry ˜0.45 g TD tube samples (evacuated below 1 torr) with 52% RH for 1 hour at a 100 mL/min flow rate. The triplicate samples were measured at 69±1 g·kg⁻¹ (water/sorbent) for a humid stream and 69±2 g·kg⁻¹ for a humid stream plus 10,500 ppm CO₂ simultaneous flow.

To compare the effect of humidified vs. dry CO₂, an experiment was conducted where a dry bed was exposed to a dry stream of CO₂ until breakthrough by removing the humidification setup on the dosing rig while maintaining the same experimental flow rate of 100 mL/min. The experiment was conducted at 10,500 ppm CO₂ and displayed a non-statistical difference of 1.87±0.02 mmol/g for the 0% humidity and 1.87±0.04 mmol/g for the humid stream. Further tests at 52% RH and 2,800 ppm CO₂ were conducted to compare pre-humidified Xplo-SA9T vs dry Xplo-SA9T resulting in similar capacities (1.057±0.009 and 1.037±0.005 mmol/g, respectively).

The performance of Xplo-SA9T was compared to literature-reported performance of SA9T. The following table summarizes the data.

| | | Capacity |
|---|---|---|
| Material | Experimental Details | (mmol/g)* |
| Literature SA9T | ~8 g, 2800 ppm CO₂, 52% humid stream, 20 min | 0.311 ± 0.027 |
| | exposure^{#} | |
| Literature SA9T | ~8 g, 2800 ppm CO₂, 52% humid stream, 1 h | 0.422 ± 0.001 |
| | exposure^{#} | |
| Xplo-SA9T sieved | ~95 mg, 500 ppm CO₂, humid stream, | 0.53 ± 0.02 |
| | breakthrough (1 h) | |
| Xplo-SA9T sieved | ~95 mg, 2800 ppm CO₂, humid stream, | 1.037 ± 0.005 |
| | breakthrough (1 h) | |
| Xplo-SA9T sieved | ~95 mg, 2800 ppm CO₂, 0% humidity, | 1.057 ± 0.009 |
| | breakthrough (1 h) | |
| Xplo-SA9T sieved | ~95 mg, 10500 ppm CO₂, humid stream, | 1.87 ± 0.04 |
| | breakthrough (1 h) | |
| Xplo-SA9T sieved | ~95 mg, 10500 ppm CO₂, 0% humidity, | 1.87 ± 0.02 |
| | breakthrough | |
| MMPA-sorbent sieved | ~72 mg, 2800 ppm CO₂, humid stream, | 0.96 ± 0.07 |
| | breakthrough (1 h) | |
| MMPA-sorbent sieved | ~72 mg, 2800 ppm CO₂, 0% humidity, | 1.06 ± 0.02 |
| | breakthrough (1 h) | |
| MMPA-sorbent sieved | ~72 mg, 10500 ppm CO₂, humid stream, | 1.84 ± 0.01 |
| | breakthrough | |
| MMPA-sorbent sieved | ~66-82 mg, 10500 ppm CO₂, humid stream, | 1.46 ± 0.03 |
| (various wt % loadings) | breakthrough | −2.21 ± 0.03 |

*= mmol CO₂ per gram of sorbent,
^{#}= conducted at a flow rate of 2.9 L/min, humid stream is at 52% RH unless specified.

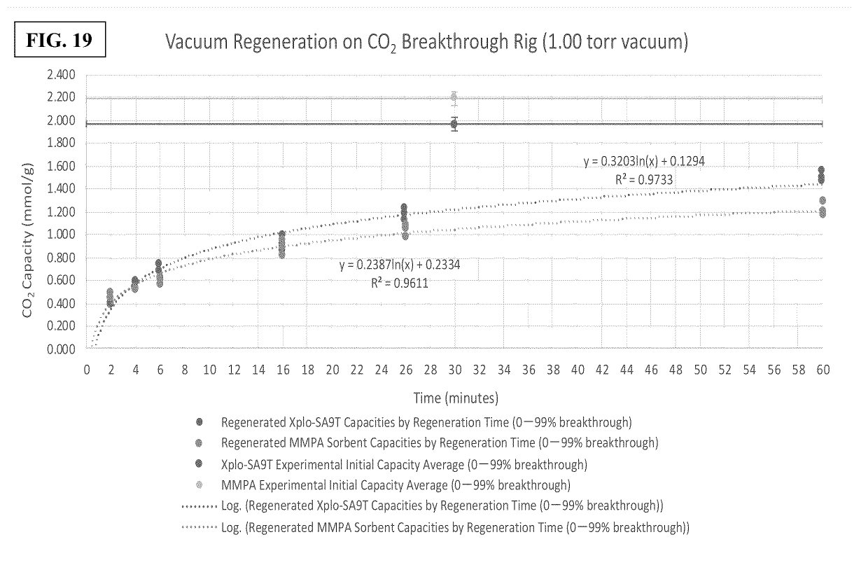

FIG. 19 depicts a graph comparing the performance of Xplo-SA9T and MMPA-sorbent (MMPA-Diaion HP2MGL) in regards to vacuum regeneration on CO₂ breakthrough rig described herein. Each time point was collected in triplicate for both Xplo-SA9T and MMPA-sorbent. In addition, new material was used between time changes to ensure equivalent testing parameters across all samples. The results indicated by an 18-sample set of 600-1000 μm sieved Xplo-SA9T at 10,500 ppm (7.98 mmHg) CO₂ and 52% RH, divulged an initial 0-99% breakthrough capacity of 1.965±0.055 mmol/g. When an 18-sample set of MMPA sorbent was evaluated using the same conditions an initial capacity of 2.183±0.060 mmol/g was revealed. Each sorbent was exposed to a 1.00 torr vacuum for a chosen time interval of 2, 4, 6, 16, 26, or 60 minutes. The corresponding capacities after vacuum regeneration were plotted and logarithmic equations were fitted to the regeneration rate curves. The rates both support the premise that secondary amines regenerate better than primary amines while still possessing an affinity for CO₂.

MMPA-sorbent is another XploSafe LLC embodiment. As compared to other known sorbents, this material has demonstrated improved CO₂ adsorption across multiple humidities, CO₂ concentrations; moreover, it does not employ the toxic reagent acrylonitrile during its synthesis.

LPEI on FPX66 was originally tested as a high CO₂ adsorbent; however, recent data at scale and higher CO₂ concentrations suggest both Xplo-SA9T and MMPA-sorbent demonstrate equally high performance. Moreover, Xplo-SA9T and MMPA-sorbent have been successfully tested in 0 to 75% relative humidity environments without any substantial (or any statistically significant—for Xplo-SA9T) loss in CO₂ adsorption capabilities. Both Xplo-SA9T and MMPA-sorbent boast high water uptake capacities compared to known desiccants.

Based upon the above, a new amine-based adsorbent was synthesized and explored in conjunction with the evaluation of Xplo-SA9T. Xplo-SA9T and the MMPA sorbent possess higher initial CO₂ capacities than expected and offer regeneration through vacuum or positive pressure flow. MMPA sorbent possesses a higher initial CO₂ adsorption capacity and similar regenerated capacity than the currently utilized and proven SA9T.

Unless otherwise specified, values indicated herein should be understood as being limited by the term “about”. As used herein, the term “about” is taken to mean a value that is within ±10%, ±5% or ±1% of the indicated value. For example, “about 6” is taken to mean 6±10%, 6 ±5% or 6±1%, respectively. As used herein, the term “major portion” is taken to mean “majority of”, or if used in combination with “minor portion is taken to mean “more than half”. As used herein, the term “minor portion” is taken to mean “minority of”, or if used in combination with “minor portion is taken to mean “less than half”.

The entire disclosures of all documents cited herein are hereby incorporated by reference in their entirety. The following materials and procedures are used to prepare exemplary embodiments of the invention and to demonstrate exemplary uses thereof. Sorbents disclosed herein can be obtained from XPLOSAFE, LLC (Stillwater, OK).

### Example 1

### Preparation of Non-Functionalized Mesoporous Silica MCM-41 Type Substrate

The mesoporous silica substrate was prepared according to a modified method of Apblett et al. (“Preparation of mesoporous silica with grafted chelating agents for uptake of metal ions” in Chemical Engineering Journal (2009), 155 (3), 916-9240) or AlOthman et al. (“Synthesis and characterization of a hexagonal mesoporous silica with enhanced thermal and hydrothermal stabilities”, in Applied Surface Science (2010), 256, 3573-3580), the entire disclosures of which are hereby incorporated by reference.

A templating solution was prepared first by dissolving 284.0 g (1.08 mol) of 1-hexadecylamine (HDA) in 1040 mL of distilled water at room temperature, sonicating for 5-10 min to produce foamy and uniform paste. A second solution was prepared by mixing 524 g (2.4 moles) of tetraethylorthosilicate, 448 mL (0.96 moles) of ethanol and 96 mL (1.6 moles) of isopropanol in under magnetic stirring at room temperature for about 45 min. The first solution was stirred for 40 min followed by the addition of 1000 mL of 1.0 M HCl solution in increments over 10-15 minutes and then the second solution in a three-necked round-bottom flask. After 5 min of stirring, 148 mL (1.2 moles) of auxiliary organic mesitylene was added to the reaction mixture, which was then stirred for an additional 25 min. After that, the stirring was stopped, and 1600 mL of distilled water was added to the mixture, which was swirled to mix and then left to age for 7 days at room temperature. The resulting solid was recovered by filtration, washed with distilled water and ethanol (three times) using a fine filter funnel.

### Example 2

### Preparation of OSU-6 (Derivatized or Underivatized) as Beads by Compression

OSU-6 powder having a particle diameter in the range of 200-400 μm was prepared according to Example 1. A mechanical pellet press was utilized to fabricate the OSU-6 beads. 10 wt. % cellulose was mixed with OSU-6 powder as a binder. The thoroughly mixed cellulose OSU-6 mixture was pressed using 4 tons of mechanical pressure in a die set to generate mechanically robust and crack-free beads with sizes of approximately 4000 μm (diameter)×4000 μm (height). The pressed beads were then calcined in a furnace at 500° C. for 12 hours to burn off the cellulose binder resulting in nanoporous beads comprising only OSU-6 mesoporous silica. No shrinkage was observed post calcination.

### Example 3

### Preparation of OSU-6 (Derivatized or Underivatized) Extruded Beads

Extruded beads containing OSU-6 sorbent were prepared as follows. OSU-6 beads from Example 2 were mixed with Ludox AM-30 colloidal silica and the mixture was then extruded in liquid nitrogen using syringe tips of desired sizes to prepare extruded beads having a diameter in the range of 2500-4000 μm.

### Example 4

### Preparation of Functionalized Mesoporous Silica

OSU-PED preparation: N-[3-(trimethoxysilyl)propyl]ethylenediamine was used to graft propylethylenediamine (PED) groups to the walls of nanoporous silica by the reaction of methoxy groups with surface hydroxyls. The reaction was performed in refluxing toluene after OSU-6 was first activated by the reaction with triethylamine. The reaction produced a yellow product that contained 15.5 wt. % organoamine groups (this excludes the silica from the reagent) incorporated.

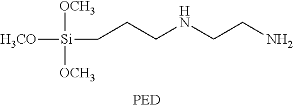 [SMILES: CO[Si](CCCNCCN)(OC)OC]

OSU-PEI and OSU-PEH preparation: The functional groups were physically impregnated into OSU-6 using solutions of 0.5 g of either the oligomer polyethylenimine (PEI) or the oligomer pentaethylenehexamine (PEH) dissolved in 20 ml of water. One gram of OSU-6 was contacted with these solutions for 24 hours, and the resulting solid was washed 3 times with water and dried to a constant weight at 90° C. PEI of different chain lengths was used to prepare related OSU-PEI sorbent derivatives.

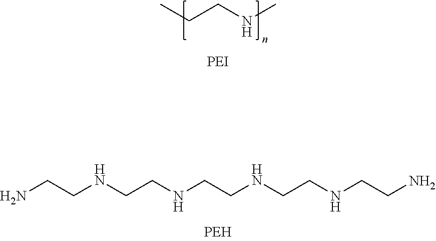

In the case of polyethyleneimine, the treated OSU-6 contained 14.1 wt. % organic amine while the pentaethylenehexamine contained 11.6 wt. %. These materials contain amine groups noncovalently bound to the surface of the OSU-6 pores. In subsequent derivatizations higher loadings were accomplished by filling the pores with the reagents.

The following sorbents with respective percentage loadings of absorption modifier were prepared: a) OSU-PED with 15% loading; b) OSU-6-PEI with 18%, 50%, and 75% loading; c) high molecular weight OSU-PEI with 52% loading; d) OSU-PEH with 15% and 55% loading; and c) OSU-PEHAD (PEHAD is polyethyleneimine hexammonium amino diacetate) with 124% loading. The percentage of loading was determined by mass gain. The chain length (expressed by molecular weight) of the PEI ranged from about 800-2000 for the branched PEI and about 2000-3000 or about 2500 (preferred) for the linear PEI.

The sorbents were characterized by thermogravimetric analysis. The mass loading of the amines on the surface functionalized OSU-6 ranged between 14-18% by weight.

### Example 5

### Preparation of Pellets of Mesoporous Silica (Derivatized or Underivatized)

Sorbent powder was pressed into 6-mm and 12-mm circular pellets using a die. The 12-mm pellets were produced by utilizing a manual pellet press (CARVER 4350.L) under an applied force of 2 tons and exposure time of 90 seconds, while the 6-mm pellets were manufactured by an automated pellet press (TDP-7) under 4 tons of applied force. No reduction in surface area at this relatively low pressure was detected. Even after pressing the sorbent powder into a pellet, the measured surface area per gram was not substantially reduced until the pressure reached 8 tons, at which a reduction in surface area of around 20-25% was observed. To ensure the durability of the pressed 6-mm pellets, 20 wt. % of cellulose was added to the pure sorbent powder before pressing. All pellets were annealed in an oven at 600° C. for 24 hours prior to sorption experiments to remove any traces of organic impurities and the cellulose binder.

### Example 6

### Prior Art Sorbents Evaluated

The sorbents of the invention were compared to the following prior art sorbents: a) silica gel functionalized with PEI-42% loading; b) SYLOBEAD MS C544; c) Zeolite 13-X.

### Example 7

### Preparation of SA9T and New Derivatives

SA9T and new derivatives were prepared as follows. Tetraethylenepentamine (TEPA) was converted to TEPAN via a Michael addition reaction with acrylonitrile. TEPA was added to 100 mL media bottle with a magnetic stirrer and 2.3 molar equivalents of acrylonitrile was added drop-wise at a sufficiently low rate to prevent the reaction mixture from exceeding 50° C. After the addition was complete, the bottle was capped and placed in an oven at 50° C. The product was then cooled and washed five times with 90 ml of hexane. It was then dried at 70° C.

Mistubishi Diaion HP2MGL resin was sourced from ThermoFisher scientific. SA9T was prepared by dissolving TEPAN in 95% ethanol and then adding the resulting solution to dried (12 hours @ 90° C.) Mistubishi Diaion HP2MGL resin until incipient wetness was achieved. The solution was allowed to permeate into the resin for 24 hours. The solvent was then removed by placing the reaction mixture in a 90° C. oven until the product was completely dry.

The concentration of the TEPAN was adjusted to achieve a loading of the resin of 75% by weight of dry resin (SA9T). The researchers synthesized two additional loadings of the TEPAN: PMMA-TEPAN with 88% and 127% loadings respectively).

### Example 8

### Preparation of FPX66-PEI

The following procedure was used to prepare the FPX66-PEI sorbent wherein FPX66 is functionalized with linear PEI. Linear polyethyleneimine was dissolved in 3.2 mL of 95% ethanol at 78° C. and then added to dried FPX66 also heated to 78° C. The mixture was heated in a sealed vial at 78° C. for 16 hours. The vial was uncapped, and the mixture was heated at 90° C. until dry. FPX66-PEI sorbents having the following loadings were prepared: 40%, 52%, and 60%.

The synthesized sorbent powders were characterized to evaluate the differences between the plain FPX66-PEI sorbent powder and various amine-functionalized materials. Fourier-transform infrared spectroscopy (FTIR) was conducted to detect impregnated functional groups. Attenuated total reflection (ATR) sampling showed that the functionalized agents (amines) were loaded inside the pores and not on the powder surface.

### Example 9

### Characterization of Sorbents

Thermogravimetric analysis (TGA) was conducted on the sorbents. This characterization helped establish an optimal conditioning temperature for the synthesized amine-functionalized medias. Thermal desorption studies were conducted to analyze off gassing of select sorbents, including PEI-functionalized FPX66 (linear and branched), OSU-6, PMMA, and Xplo-SA9T at 38° C. using a gas chromatography/mass spectrometry system. The linear PEI-functionalized FPX66-PEI exhibited negligible levels of outgassed volatiles, which were lower than those of the other sorbents by more than an order of magnitude even without prior thermal conditioning. The high stability of FPX66-PEI combined with a high CO₂ adsorption capacity and good vacuum regeneration ability make it a preferred sorbent.

A detailed sorbent characterization procedure based on the Brunauer-Emmett-Teller (BET) and Bayer-Joyner-Halenda (BJH) methods was developed to determine its surface area, pore volume, and pore size distribution. The table below provides the measured surface areas, average pore sizes, and total pore volumes of a select number of the non-functionalized and functionalized sorbents. No major decrease in the total pore volume was observed on the OSU-6 sorbents at the current loadings of around 5-18% of different amines.

| | | BET | | |
|---|---|---|---|---|
| | | surface | Average | Total pore |
| | | area | pore size | volume |
| # | Sorbent | (m²/g) | (nm) | (cm³/g) |
| 1 | OSU-6 (40-60 mesh) | 534 | 3.9 | 1.1 |
| 2 | OSU-6 beads (4 mm) | 496 | 3.7 | 0.9 |
| 3 | OSU-6/Ludox Am-30 extruded pellets | 303 | — | 0.4 |
| 4 | PED-functionalized OSU-6 (15% loading) | 400 | 2.99 | 0.6 |
| 5 | PEI-functionalized OSU-6 (18% loading) | 266 | 4.99 | 0.8 |
| 6 | PEH-functionalized OSU-6 (15% loading) | 272 | 4.1 | 0.8 |
| 7 | Xplo-SA9T (SA9T analog) | 21 | 2.2 | 0.1 |
| 8 | PEI-functionalized FPX-66 (branched, 61% | 91 | 1.5 | 0.3 |
| | loading) | | | |
| 9 | TEPAN-functionalized FPX-66 (41% | 211 | 1.2 | 0.6 |
| | loading) | | | |
| 10 | PEI-functionalized FPX-66 (linear, 40% | 235 | 1.1 | 0.6 |
| | loading) | | | |

### Example 10

### Characterization of Water Sorption and Uptake Rate

The water uptake by OSU-6-based sorbents was studied using the testing system described herein. It consisted of a parallel arrangement of sorbent columns with OSU-6 masses of 50 mg and lengths of 14 mm. It also included a mixing tube (blank sorbent tube with a piece of glass wool). To maintain a desired humidity level for all sorbent tubes, an air/water gas mixture simultaneously flowed through all columns at the same rate (100 mL/min). The relative humidity (RH) of this mixture was measured by an Omega RH—USB temperature/humidity sensor attached to a column outlet, while the flow uniformness was confirmed using an Omega flow meter. Prior to water uptake measurements, the columns were conditioned inside a Markes TC-20 tube conditioner at a temperature of 250° C. for 3 hours for OSU-6 or 100° C. for 1 hour for the resin. Water adsorption was measured at two different RH levels (40% and 85%), which were achieved by varying the ratio between the dry and humid streams in the humidification setup. After setting a required humidity level, the conditioned sorbent columns were simultaneously attached to the outlets, and their masses were measured at certain times intervals for up to 10 hours. The water uptake in each column was determined as a difference between its masses before and after exposure. The experiment was continued until the mass of adsorbed water reached a constant.

The results demonstrated that the adsorbed water mass at RH=85% is one order of magnitude higher than the water mass adsorbed at RH=40%. The water saturation time at RH=85% (approximately 6 h) is also significantly larger than that at RH=40% (approximately 1 h). The water uptake capacities determined from the results of a fitting procedure were 9.0±0.8 g/100 g sorbent at RH=40% and 92±2 g/100 g sorbent at RH=85%, which exceeded the spacesuit the requirement of 7.0 g H₂O 100 g sorbent at a temperature of ±25° C. and dew point of ±15° C. (corresponding to RH=54%). In comparison, the water uptake capacity for FPX66-PEI (linear, 61% loading) was 8.9±0.6 g/100 g sorbent at RH=39%.

### Example 11

### Characterization of CO₂ Sorption and Uptake Rate

A testing system was setup for conducting CO₂ dosing and breakthrough evaluations of sorbent beds. The system consisted of a calibrated gas cylinder (CO₂ source), ultrahigh-purity nitrogen cylinder, humidity module, mass flow controllers, sorbate flow control switch, and exhaust line. The mass flow controllers are used to regulate the flow and concentration of the target analyte. To precisely control the target gas flow, a single push button switch is used to initiate and stop the gas flow with a response time of a few microseconds limited by the mechanical valve on the flow controller. The humidity module was used to generate precise humidity levels from 0 to 90%. The dosing apparatus was mounted on an aluminum metal support with dimensions of 44″×26″ and connected to a separate gas exhaust line.

The sorbent column consisted of glass thermal desorption tubes with a length of 10 cm, inner diameter of 3.5 mm, and outer diameter of 6 mm filled with fixed column length (14.1 mm) of the various synthesized sorbent media including OSU-6, amine-functionalized OSU-6 sorbents, commercial of the shelf media, and resin functionalized amines including Xplo-SA9T with masses ranging from 50 to 70 mg. A sensor array was assembled and connected to the outlet end of the sorbent column to detect and quantify in real-time the target analytes CO₂ and potential byproducts including ammonia in the same stream. The CO₂ concentration in the stream was set at approximately 500 ppm, and the total gas flow rate was 100 mL/min. Research grade nitrogen gas served as a carrier gas. A required humidity level was achieved by mixing the dry gas stream with the carrier gas passing through a water bubbler at a certain ratio.

The setup was used to evaluate the synthesized sorbent media for the uptake of CO₂. Three blanks (sorbent columns with no sorbent media) were run to test the doser and sensor measurement precision. The sorbent columns were typically conditioned at 110° C. for 1 hour before exposure to the target analyte (500 ppm) of CO₂. Before starting the CO₂ flow, the carrier gas (ultrahigh-purity nitrogen) was passed through the analyzed column for 10 minutes to remove residual CO₂ molecules from the sorbent. The experiment was stopped when the CO₂ amount at the column outlet reached saturation and remained constant for at least 10 min. Using this method, the 19 sorbent types with different loadings of functionalizing agents (28 different medias) were evaluated to determine their CO₂ adsorption capacities.

### Example 12

### Characterization of CO₂ and Water Desorption

To investigate the CO₂ desorption regeneration of the studied sorbents, both thermal and vacuum regeneration studies were performed for select columns. In thermal regeneration experiments, a previously CO₂-exposed sorbent column was heated to at 110° C. for 1 hour in a stream of ultrahigh-pure nitrogen gas, after which a breakthrough experiment was repeated. Thermal regeneration was further conducted in order to quickly evaluate and compare regeneration potential of sorbents functionalized with branched vs. linear amines. For the sorbent functionalized with branched amines (such as Heximid-functionalized OSU-6, PEI-functionalized FPX66, and PEI-functionalized PMMA), the uptake capacity decreased by 11-13% after thermal regeneration, and the shapes of their breakthrough curves were similar to those obtained for the pristine sorbents. However, no decrease in capacity was observed after regenerating FXP66 resin functionalized by linear PEI. Thus, linear amines exhibited better propensity to regenerate when compared to branched amines.

Vacuum regeneration experiments were performed using the system described herein. It consisted of a sub-atmospheric back pressure gas regulator connected to a vacuum pump with a minimum pressure of 15 mTorr. This regulator maintained a constant pressure upstream in a manifold connected to a sorbent column, vacuum pressure gauge, and single-stage sub-atmospheric pressure for minor pressure adjustments. The fabricated setup maintained a stable pressure of approximately 1 Torr (140 Pa) specified in the NASA solicitation.

### Example 13

### Preparation of TEPAN

The procedure of Filburn (dissertation: An investigation into the absorption of carbon dioxide by amine coated polymeric supports. University of Connecticut, 2003) was used to prepare TEPAN and ultimately the Xplo-SA9T adsorbent, which is polymethylmethacrylate (PMMA) derivatized with acrylonitrile-modified tetraethylenepentamine (TEPAN), which is a partially cyanoethylated tetraethylene pentaamine (tetraethylene pentamine acrylonitrile. Tetraethylenepentamine is cooled and an excess (2.3 equivalents) of acrylonitrile is added dropwise while carefully monitoring the temperature to control the exothermic reaction. The reaction is allowed to stand after addition then carefully heated to 50° C. for at least 1 hour. The corresponding amine is washed with n-hexane and dried (at least 3 days dependent on scale) then periodically examined by NMR to determine the relative level of product compared to unreacted starting material if any. Once only TEPAN remains, and is visible by proton NMR spectroscopy, the material is considered pure.

### Example 14

### Preparation of MMPA

The amine designated as MMPA is synthesized by a stoichiometric reaction between tetraethylenepentamine and methyl methacrylate in a neat reaction. The reaction is refluxed for at least one hour dependent on the reaction scale. Once the reaction is completed, verified by NMR spectroscopy, any reaction volatiles and/or byproducts are removed in-vacuo.

### Example 15

### Preparation of MMPA Modified or Derivatized Sorbent

The resin (Mitsubishi Diaion HP2MGL) is dried thoroughly to remove any water and volatile contaminants. The amine known as MMPA is dissolved in ethanol (with different percent weight loadings) and added to the dried resin. The combined mixture is rocked for at least 24 hours (dependent on scale) and then subjected to high vacuum until the material is able to maintain a vacuum threshold below 1 torr (dependent on scale). An adsorbent was synthesized in 75% wt loading labeled as MMPA-sorbent in a 1.5-kilogram scale at 93% yield.

The MMPA-sorbent (MMPA derivatized Diaion HP2MGL) exhibited the following properties: a density of 0.3943±0.0100 g/mL and a 0-99% CO₂ breakthrough capacity of 1.843 ±0.010 mmol/g at 10500 ppm (7.98 mmHg) CO₂ concentration (CO₂/adsorbent). The water adsorption capacity within 1 hour is 87.9815±0.1196 g/kg (water/adsorbent). The adsorbent was sieved to 600-1000 μm particles to reduce pressure drop across the material, CO₂ and water capacities reported are with sieved material.

Further resins are investigated and dried thoroughly. The dried resins are exposed to dissolved amine solutions and rocked/rotated for a significant time to afford proper distribution. The corresponding solutions are dried to generate the solid preferred adsorbents.

### Example 16

### Preparation of Xplo-SA9T

The resin (Mitsubishi Diaion HP2MGL) is dried thoroughly to remove any water and volatile contaminants. It is dried until the vacuum reading matches the maximum vacuum threshold of the drying equipment (mtorr range). The amine known as TEPAN is dissolved in ethanol (with 75% weight loading) and added to the dried resin. The combined mixture is rocked for at least 24 hours (dependent on scale) and then subjected to high vacuum until the material is able to maintain a vacuum threshold below 1 torr (dependent on scale). The material is tested by NMR spectroscopy to determine successful amine retention, CO₂ breakthrough capacity to determine effectivity, density, and TD-GC/MS analysis to ensure material is clean of any foreign contaminant that could off-gas.

### Example 17

Preparation of Sorbent Modified or Derivatized with Polyethyleneamine of Formula II

The polyethyleneimine solid is exposed to ethanol and heated to at least 60° C. to dissolve. The dried resin (Amberlite FPX66, Mitsubishi Diaion HP2MGL, etc) is then added to the hot solution and allowed to remain hot and rotate for at least 16 hours. The corresponding cooled solution is dried under a vacuum until the material is able to maintain a vacuum threshold below 1 torr to achieve the desired adsorbent.

Amine manipulations were performed under an inert atmosphere where required. Solvents were purchased from commercial vendors and used as such. Reagents were purchased from commercial vendors and further purified when required. Chloroform-d′3 for NMR spectroscopy was used as purchased from Fisher Scientific and used as received. The SEM used is a ThermoFisher Scientific FEI Quanta 600 FEG Mk2 ESEM (2006). The nominal resolution is 10 nm for a tin ball standard. Any multinuclear NMR spectra were recorded on a Bruker AVANCE 400 MHz instrument. TD-GC/MS analysis was completed using an Agilent Technologies 6890N Gas Chromatograph, a Hewlett Packard 5973 Mass Selective Detector, and a Markes TD-100 Thermal Desorber. Elemental analysis samples were sent to Atlantic Microlab and were evaluated with a Carlo Erba 1108 Analyzer. The purity of new complexes was established by 1H NMR spectroscopy and elemental analysis.

The above is a detailed description of particular embodiments of the invention. It will be appreciated that, although specific embodiments of the invention have been described herein for purposes of illustration, various modifications may be made without departing from the spirit and scope of the invention. Accordingly, the invention is not limited except as by the appended claims. All embodiments disclosed and claimed herein can be made and executed without undue experimentation in light of the present disclosure.

All integers and fractions within the limits/ranges specified herein are contemplated.

1) A vacuum regenerable sorbent comprising a porous substrate derivatized with one or more polyamine adsorption modifiers, wherein
the substrate is selected from the group consisting of mesoporous silica, styrene-divinylbenzene copolymer (S-DVB), polyalkyl ester polymer, ion exchange resin, anion exchange resin, weakly basic polyamine anion exchange resin, polymethacrylate polymer, and polymethylmethacrylate (PMMA) polymer, nonionic resin, ethylvinylbenzene-divinylbenzene copolymer, and cross-linked aromatic polymer; and
the sorbent adsorbs, from air, one or more sorbates selected from the group consisting of water, carbon dioxide, volatile compound, and semi-volatile compound.

2) The sorbent of claim 1, wherein the polyamine adsorption modifier is independently selected at each occurrence from the group consisting of linear polyethyleneimine (PEI) polymer, tetraethylenepentamine (TEPAN) which may or may not be branched, polyethyleneamine of Formula I, and polyethyleneamine of Formula II, and wherein the polyamine adsorption modifier of Formula I is
R¹—HN(CH₂)₂NH(CH₂)₂NH(CH₂)₂NH(CH₂)₂NH—R² Formula I
wherein:
R¹ is independently selected at each occurrence from the group consisting of hydrogen, methyl ester, alkyl, and aryl substituted alkyl;
R² independently selected at each occurrence from the group consisting of methyl ester, alkyl, and aryl substituted alkyl; and
R¹ may or may not be the same as R²; and
the polyamine adsorption modifier of Formula II is
R¹—HN(CH₂)₂NH(CH₂)₂NH(CH₂)₂NH(CH₂)₂NH(CH₂)₂NH—R² Formula II
wherein:
R¹ is independently selected at each occurrence from the group consisting of hydrogen, alkylnitrile, alkyl, and aryl substituted alkyl;
R² independently selected at each occurrence from the group consisting of alkylnitrile, alkyl, and aryl substituted alkyl; and
R₁ may or may not be the same as R².

3) The sorbent of claim 2, wherein the polyamine adsorption modifier of Formula I or Formula II is independently selected at each occurrence from the group consisting of

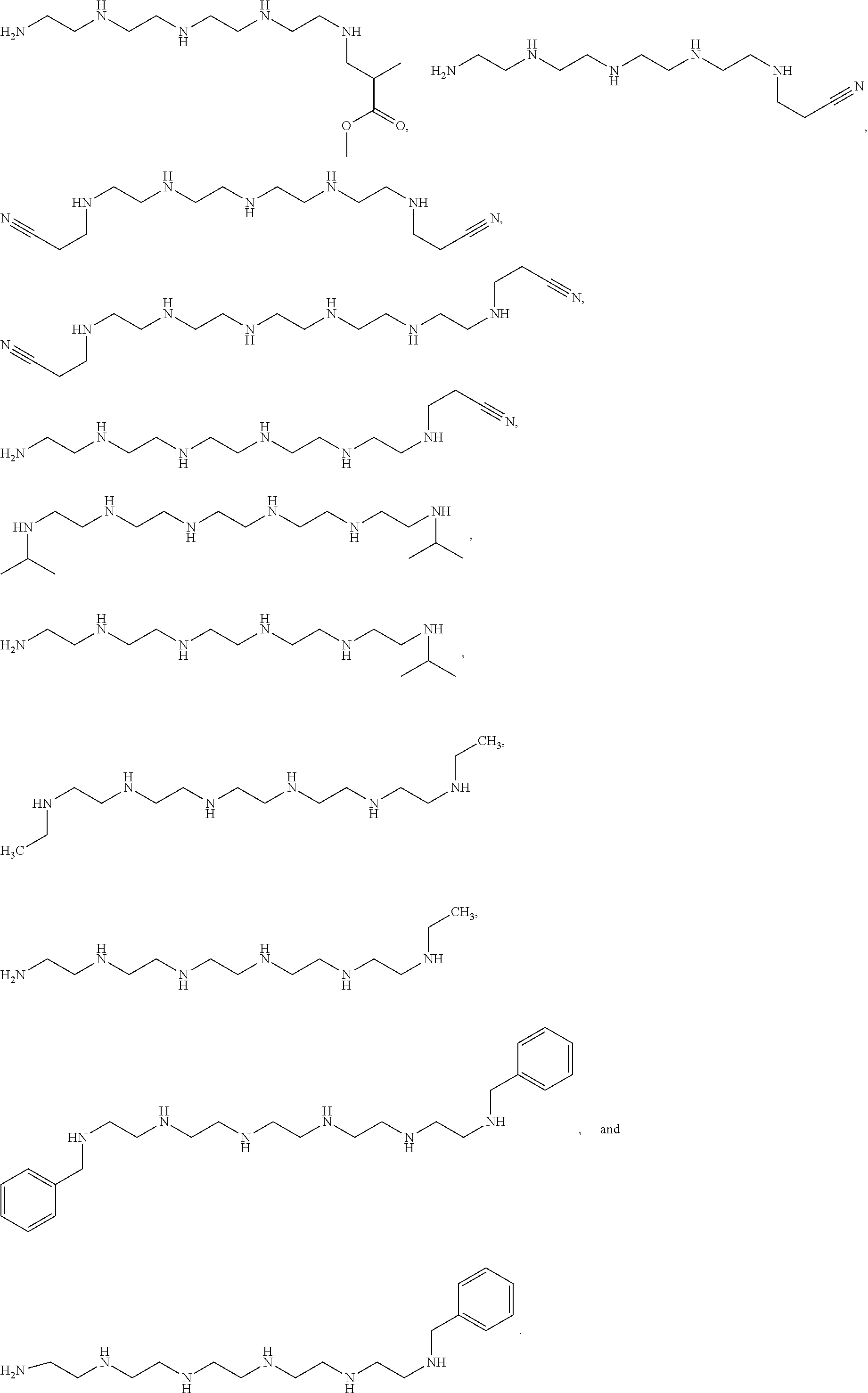

4) The sorbent of claim 1, wherein sorbent is vacuum regenerable by exposing sorbate-containing sorbent to a vacuum regeneration phase of at approximately 1 torr or higher for approximately two minutes or longer.

5) The sorbent of claim 4, wherein a) the sorbent exhibits a cyclic uptake capacity greater than 2.0 g CO₂/100 g of sorbent at 2-to-3 minute half-cycle (e.g., adsorb for 2 minutes/desorb for 2 minutes) and desorbs the CO₂ during the reduced pressure half-cycle of a swing pressure regeneration cycle (desorption pressure of 140 Pa (approximately 1 Torr) conducted for a 2-minute half-cycle); b) the sorbent can be exposed to thermal cycling (up to 60° C.), and to high flow of air, humidity and gases (CO₂ and nitrogen) at flows exceeding 2 L/min; and vacuum cycling at 140 Pa (approximately 1 Torr) for multiples cycles; and/or c) the sorbent adsorbs volatile and semi volatile contaminants.

6) The sorbent of claim 1, wherein a) the sorbent has been sieved; b) the sorbent has a particle size in the range of about 600-1000 microns; c) the sorbent has a density in the range of about 0.2-0.6 g/mL; d) the sorbent has a water uptake capacity within 1 hour of exposure at 52% RH and at least a 100 mL/min flow rate of about 60-100 g/kg; c) the sorbent has a 0-99% CO₂ breakthrough capacity of about 0.7 mmol/g or higher; or f) a combination of any two or more of the above.

7) The sorbent of claim 1, wherein the sorbent is selected from the group consisting of FPX66-PEI, FPX66-TEPAN, OSU-6-PEI, PMMA-TEPAN, and PMMA-PEI.

8) A sorbent holder comprising one or more sorbents according to claim 1 enclosed within an air permeable material, wherein the sorbent holder is adapted to allow the forced flow of contaminated air therethrough, thereby exposing said contaminated air to one or more sorbents which captures contaminants in the air.

9) The sorbent holder of claim 8, wherein two or more sorbents are present.

10) The sorbent holder of claim 8, wherein a combination of functionalized OSU-6, non-functionalized OSU-6, and OSU-6-PEI is present.

11) A container comprising one or more sorbent holders according to claim 8 disposed within a body comprising at least one entry port and at least one exit port, wherein the container is adapted to allow the forced flow of air therethrough, whereby contaminated air enters through the entry port and decontaminated air exits through the exit port.

12) The container of claim 11, wherein the body comprises a housing, a first end comprising said entry port, and a second end comprising said exit port, said housing, first end and second end defining one or more chambers.

13) The container of claim 12, wherein a) said first and second ends are, independently upon each occurrence, removable from or permanent with the body; and/or b) said entry ports and exit ports are, independently upon each occurrence, flanged or not flanged.

14) The container of claim 13 further comprising one or more of the following: a) at least one sorbent holder disposed within said one or more chambers; b) a first particle filter conductively associated with said entry port; c) a second particle filter conductively associated with said exit port; d) a first support plate disposed between said entry port and said at least one sorbent holder; e) a second support plate disposed between said exit port and said at least one sorbent holder; f) one or more fasteners; and g) one or more seals.

15) An air treatment system comprising one or more containers according to claim 11.

16) The system of claim 15 comprising at least two of said containers, wherein the containers are adapted for to undergo pressure swing cycling regeneration sequentially, simultaneously, or in an overlapping manner.

17) The system of claim 16, wherein during operation of the device at least one of the containers treats air while at least one of the other containers undergoes pressure swing cycling regeneration.

18) The system of claim 15 comprising a) one or more containers comprising one or more vacuum regenerable sorbents contained therein; b) one or more pumps to force air through said one or more containers; and c) a vacuum source and associated valve.

19) (canceled)

20) (canceled)

21) (canceled)

22) (canceled)

23) (canceled)

24) A method of decontaminating contaminated air in an enclosed habitable space, the method comprising treating said contaminated air with a sorbent according to claim 1.

25) A method of regenerating a contaminated sorbent, the method comprising exposing said contaminated sorbent to a vacuum of at approximately 1 torr or higher for a period of at least about approximately 2 min or longer, thereby forming a sorbent as defined according to claim 1.
